(19) United States
(12) Patent Application Publication
(10) Pub. No.: US 2010/0309186 A1
(43) Pub. Date: Dec. 9, 2010

(54) Drive method of display device

(75) Inventors: Tetsuo Minami, Tokyo (JP); Katsuhide Uchino, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/662,924

(22) Filed: May 12, 2010

(30) Foreign Application Priority Data
Jun. 3, 2009 (JP) 2009-133606

(51) Int. Cl. G09G 5/00

(52) U.S. Cl. 345/211

(57) ABSTRACT

A drive method of a display device includes the steps of: performing threshold voltage cancel processing at least once, which changes a potential of a second node of a display device toward a potential obtained by subtracting a threshold voltage of a drive transistor from a potential of a first node by applying a given drive voltage to one source/drain region of the drive transistor from a feeding line while maintaining the potential of the first node; and then, performing writing processing which applies a video signal to the first node from a data line through a write transistor, wherein the sum of lengths of periods in which the threshold voltage cancel processing is performed is so set as to be shorter as a frame frequency becomes higher.

### BACKGROUND OF THE INVENTION

1. Field of the Invention

The present invention relates to a drive method of a display device.

2. Description of the Related Art

A display element including a current-drive type light emitting portion and a display device including such display element are well known. For example, a display element including an organic electroluminescence light emitting portion (also referred to merely as an organic EL display element in the following description) using electroluminescence (also referred to as EL in the following description) as an organic material receives attention as a display device capable of emitting light with high luminance by low-voltage direct current drive.

For example, in a display device including the organic EL display element (also referred to merely as an organic EL display device), a passive matrix method and an active matrix method are known as drive methods in the same manner as a liquid crystal display device. The active matrix method has a disadvantage that the configuration becomes complicated, however, it has also an advantage that luminance of an image can be increased and the like. The organic EL display element driven by the active matrix method includes, in addition to a light emitting portion having an organic layer and the like including a light emitting layer, a drive circuit for driving the light emitting portion.

As a circuit for driving the organic electroluminescence light emitting portion (also referred to merely as a light emitting portion in the following description), a drive circuit including two transistors and one capacitor unit (referred to as a 2Tr/Ic drive circuit) is known from, for example, JP-A-2007-310311 (Patent Document 1). The 2Tr/Ic drive circuit includes two transistors of a write transistor TR_{W} and a drive transistor TR_{D}, and further includes one capacitor unit C₁ as shown in FIG. 2. Here, the other source/drain region of the drive transistor TR_{D} configures a second node ND₂ and a gate electrode of the drive transistor TR_{D} configures a first node ND₁.

A cathode electrode of a light emitting portion ELP is connected to a second feeding line PS2. A voltage V_{Cat} (for example, 0V) is applied to the second feeding line PS2.

As shown in a timing chart of FIG. 4, pre-processing for performing threshold voltage cancel processing is executed in [Period-TP(2)_{1A}]. That is, a first node initialization voltage V_{0fs} (for example, 0V) is applied to the first node ND₁ from a data line DTL through the write transistor TR_{W} which has been turned on by a scanning signal from a scanning line SCL. According to this, a potential of the first node ND₁ will be V_{ofs}. A second node initialization voltage V_{CC-L} (for example, −10V) is applied to a second node ND₂ from a power supply unit 100 through the drive transistor TR_{D}. According to this, a potential of the second node ND₂ will be V_{CC-L}. A threshold voltage of the drive transistor TR_{D} is represented as a voltage Vth (for example, 3V). The voltage difference between the gate electrode and the other source/drain region of the drive transistor TR_{D} (also referred to as a source region for convenience in the following description) is more than Vth, and the drive transistor TR_{D} is in on-state.

Next, threshold voltage cancel processing is performed over a period from [Period-TP(2)_{1B}] to [Period-TP(2)₅]. Specifically, first threshold voltage cancel processing is performed in [Period-TP(2)_{1B}]. Specifically, second threshold voltage cancel processing is performed in [Period-TP(2)₃], then, third threshold voltage cancel processing is performed in [Period-TP(2)₅].

In [Period-TP(2)_{1B}], a voltage of the power supply unit 100 is switched from the second node initialization voltage V_{CC-L} to a drive voltage V_{CC-H} (for example, 20V) while maintaining on-state of the write transistor TR_{W}. As a result, the potential of the second node ND₂ is changed toward a potential obtained by subtracting the threshold voltage Vth of the drive transistor TR_{D} from the potential of the first node ND₁. That is, the potential of the second node ND₂ is increased.

When [Period-TP(2)_{1B}] is sufficiently long, the potential difference between the gate electrode and the other source/drain region of the drive transistor TR_{D} reaches the threshold Vth, and the drive transistor TR_{D} is turned off. That is, the potential of the second node ND₂ becomes close to (V_{ofs}−Vₜₕ) and finally becomes (V_{ofs}−Vₜₕ) However, in the example shown in FIG. 4, the length of [Period-TP(2)_{1B}] is not sufficient for changing the potential of the second node ND₂ sufficiently, and the potential of the second node ND₂ reaches a given potential V₁ satisfying the relation V_{CC-L}<V₁<(V_{ofs}−Vₜₕ) at the end of [Period-TP(2)_{1b}].

At the beginning of [Period-TP(2)₂], a voltage of the data line DTL is switched from the first node initialization voltage V_{ofs} to a video signal V_{Sig}_{_{—}}ₘ₋₂. The write transistor TR_{W} is turned off by the signal from the scanning line SCL at the beginning of [Period-TP(2)₂] so that the video signal V_{Sig}_{_{—}}ₘ₋₂ is not applied to the first node ND₁. As a result, the first node ND₁ becomes in a floating state.

As the drive voltage V_{CC-H} is applied to one source/drain region of the drive transistor TR_{D} from the power supply unit 100, the potential of the second node ND₂ is increased to a given potential V₂ from the potential V₁. On the other hand, the gate electrode of the drive transistor TR_{D} is in the floating state and the capacitor unit C₁ exists, therefore, a bootstrap operation is generated at the gate electrode of the drive transistor TR_{D}. Accordingly, the potential of the first node ND₁ is increased in accordance with potential change of the second node ND₂.

At the beginning of [Period-TP(2)₃], the voltage of the data line DTL is switched from the video signal V_{Sig}_{_{—}}ₘ₋₂ to the first node initialization voltage V_{ofs}. At the beginning of [Period-TP(2)₃], the write transistor TR_{W} is turned on by the signal from the scanning line SCL. As a result, the potential of the first node ND₁ becomes V_{ofs}. The drive voltage V_{CC-H} is applied to one source/drain region of the drive transistor TR_{D} from the power supply unit 100. As a result, the potential of the second node ND₂ is changed toward a potential obtained by subtracting the threshold voltage Vₜₕ of the drive transistor TR_{D} from the potential of the first node ND₁. That is, the potential of the second node ND₂ is increased from the potential V₂ to a given potential V₃.

At the beginning of [Period-TP(2)₄], the voltage of the data line DTL is switched from the first node initialization voltage V_{0fs} to a video signal V_{Sig}_{_{—}}ₘ₋₁. At the beginning of [Period-TP(2)₄], the write transistor TR_{W} is turned off by the signal from the scanning line SCL so that the video signal V_{Sig}_{_{—}}ₘ₋₁ is not applied to the first node ND₁. As a result, the first node ND₁ becomes in the floating state.

The drive voltage V_{CC-H} is applied to one source/drain region of the drive transistor TR_{D} from the power supply unit 100, therefore, the potential of the second node ND₂ is increased from the potential V₃ to a given potential V₄. On the other hand, the gate electrode of the drive transistor TR_{D} is in the floating state and there exists the capacitor unit C₁, therefore, the bootstrap operation is generated at the gate electrode of the drive transistor TR_{D}. Accordingly, the potential of the first node ND₁ is increased in accordance with potential change of the second node ND₂.

As a presupposition of an operation in [Period-TP(2)₅], it is necessary that the potential V₄ of the second node ND₂ is lower than (V_{ofs}−Vₜₕ) at the beginning of [Period-TP(2)₅]. The length from the beginning of [Period-TP(2)_{1B}] to the beginning of [Period-TP(2)₅] is so determined as to satisfy a condition of V₄<(V_{ofs-L}−Vₜₕ).

The operation of [Period-TP(2)₅] is basically the same as the operation explained in [Period-TP(2)₃]. At the beginning of [Period-TP(2)₅], the voltage of the data line DTL is switched from the video signal V_{Sig}_{_{—}}ₘ₋₁ to the first node initialization voltage V_{0fs}. At the beginning of [Period-TP(2)₅], the write transistor TR_{W} is turned on by the signal from the scanning line SCL.

The first node ND₁ is in a state that the first node initialization voltage V_{0fs} is applied from the data line DTL through the write transistor TR_{W}. The drive voltage V_{CC-H} is applied to one source/drain region of the drive transistor TR_{D} from the power supply unit 100. As in the same manner as explained in [Period-TP(2)₃], the potential of the second node ND₂ is changed toward a potential obtained by subtracting the threshold voltage Vₜₕ of the drive transistor TR_{D} from the potential of the first node ND₁. When a potential difference between the gate electrode and the other source/drain region of the drive transistor TR_{D} reaches Vₜₕ, the drive transistor TR_{D} is turned off. In this state, the potential of the second node ND₂ is almost (V_{ofs}−Vₜₕ).

After that, in [Period-TP(2)_{6A}], the write transistor TR_{W} is turned off. Then, the voltage of the data line DTL is made to be a voltage corresponding to a video signal [Video signal (drive signal, luminance signal) V_{Sig}_{_{—}}ₘ for controlling luminance in the light emitting portion ELP.

Next, in [Period-TP(2)_{6D]}, writing processing is performed. Specifically, the write transistor TR_{W} is turned on by allowing the scanning line SCL to be high level. As a result, the potential of the first node ND₁ is increased to the video signal V_{Sig}_{_{—}}ₘ.

In the above operation, the video signal V_{Sig}_{_{—}}ₘ is applied to the gate electrode of the drive transistor TR_{D} in the state in which the drive voltage V_{CC-H} is applied to one source/drain region of the drive transistor TR_{D} from the power supply unit 100. Accordingly, as shown in FIG. 4, the potential of the second node ND₂ is increased in [Period-TP(2)_{6B}]. The increased amount ΔV of the potential (potential correction value) will be described later. When the potential of the gate electrode of the drive transistor TR_{D} (first node ND₁) is V_{g} and the potential of the other source/drain region (second node ND₂) thereof is Vₛ, a value of V_{g} and a value of Vₛ will be as follows when the increased amount ΔV of the potential of the second node ND₂ is not considered. A potential difference between the first node ND₁ and the second node ND₂, namely, a potential difference V_{gs} between the gate electrode of the drive transistor TR_{D} and the other source/drain region functioning as a source region can be represented by the following formula (A).

V_{g}=V_{Sig}_{_{—}}ₘ

Vₛ≅V_{ofs}−Vₜₕ

V_{gs}≅V_{Sig}_{_{—}}ₘ−(V_{ofs}−Vₜₕ) (A)

That is, V_{gs} obtained in the writing processing with respect to the drive transistor TR_{D} depends only on the video signal V_{Sig}_{_{—}}ₘ for controlling the luminance in the light emitting portion ELP, the threshold voltage Vₜₕ of the drive transistor TR_{D} and the voltage V_{ofs} for initializing the potential of the gate electrode of the drive transistor TR_{D}. Additionally, V_{gs} has no relation to a threshold voltage V_{th-EL} of the light emitting portion ELP.

Next, mobility correction processing will be briefly explained. In the above-described operation, mobility correction processing for changing the potential of the other source/drain region of the drive transistor TR_{D} (namely, the potential of the second node ND₂) in accordance with characteristics (for example, the size of mobility μ) of the drive transistor TR_{D} is performed together with the writing processing.

As described above, the video signal V_{Sig}_{_{—}}ₘ is applied to the gate electrode of the drive transistor TR_{D} in the state in which the drive voltage V_{CC-H} is applied to the one source/drain region of the drive transistor TR_{D} from the power supply unit 100. Here, as shown in FIG. 4, the potential of the second node ND₂ is increased in [Period-TP(2)_{6B}]. As a result, when a value of the mobility μ of the drive transistor TR_{D} is large, the increased amount ΔV of the potential (potential correction value) in the source region of the drive transistor TR_{D} is increased. When the value of the mobility μ of the drive transistor TR_{D} is small, the increased amount ΔV of the potential (potential correction value) in the source region of the drive transistor TR_{D} is reduced. The potential difference V_{gs} between the gate electrode and the source region of the drive transistor TR_{D} is deformed from the formula (A) to the following formula (B).

V_{gs}≅V_{Sig}_{_{—}}ₘ−(V_{ofs}−Vₜₕ)−ΔV (B)

According to the above operation, the threshold voltage cancel processing, the writing processing and the mobility correction processing are completed. Then, at the beginning of [Period-TP(2)_{6c}] after that, the first node ND₁ is allowed to be in the floating state by turning off the write transistor TR_{W} based on the scanning signal from the scanning line SCL. One source/drain region (also referred to as a drain region for convenience in the following description) is in a state in which the drive voltage V_{CC-H} is applied from the power supply unit 100. As the result of the above, the potential of the second node ND₂ is increased and a phenomenon similar to a so-called bootstrap circuit is generated at the gate electrode of the drive transistor TR_{D}, then, the potential of the first node ND₁ is increased. The potential difference Vgs between the gate electrode and the source region of the drive transistor. TR_{D} maintains the value of the formula (B). Electric current flowing through the light emitting portion ELP is a drain current I_{ds} flowing from the drain region to the source region of the drive transistor TR_{D}. When the drive transistor TR_{D} ideally operates in a saturation region, the drain current I_{ds} can be represented by the following formula (C). The light emitting portion ELP emits light corresponding to a value of the drain current I_{ds}. A coefficient “k” will be described later.

$$\begin{matrix}Ids = k \cdot μ \cdot {( {V}_{gs} = {V}_{th} )}^{2} \\ = k \cdot μ \cdot {( {V}_{Sig\_m} - {V}_{ofs} - Δ V )}^{2}\end{matrix} \qquad ( C )$$

According to the above formula (C), the drain current I_{ds} is in proportion to the mobility μ. On the other hand, the larger the mobility μ of the drive transistor TR_{D} is, the larger the potential correction value ΔV becomes as well as the smaller a value of (V_{Sig}_{_{—}}ₘ−V_{ofs}−ΔV)² in the formula (C) becomes. Accordingly, variations of the drain current I_{ds} caused by variations the mobility μ of the drive transistor can be corrected.

Operations of the 2Tr/1C drive circuit the outline of which has been explained as the above will be explained later.

### SUMMARY OF THE INVENTION

A frame frequency (frame rate) at the time of displaying video on a display device can take various values according to, for example, broadcasting systems. It is preferable to set the frame frequency to be high in order to reduce the residual image effect at the time of displaying moving pictures. Accordingly, it is desirable that the display device can display video so as to correspond to various frame frequencies. For example, a configuration in which a horizontal scanning period during which display elements of respective rows is set to a fixed length regardless of the frame frequency to display video so as to correspond to various frequencies. In this case, the operations performed during the period from [Period-TP(2)_{1A}] to [Period-TP(2)_{6c}] are performed under the same conditions regardless of the frame frequency. However, there occurs a problem that a phenomenon in which the value of a video signal at the time of black display varies according to the frame frequency is seen and it is necessary to adjust the value of the video signal according to the frame frequency.

Therefore, it is desirable to provide a drive method of a display device capable of displaying video in respective frequencies in good condition without adjusting the value of the display signal.

According to an embodiment of the invention, there is provided a drive method of a display device, which uses the display device including

(1) the total N×M pieces of display elements in which N-pieces in a first direction and M-pieces in a second direction different from the first direction are arranged in a two-dimensional matrix state, each having a current-drive type light emitting portion and a drive circuit,

(2) M-pieces of scanning lines extending in the first direction,

(3) N-pieces of data lines extending in the second direction and

(4) M-pieces of feeding lines extending in the first direction,

in which the drive circuit includes a write transistor, a drive transistor and a capacitor unit, in the display element of the m-th row (m=1, 2 . . . , M) and the n-th column (n=1, 2 . . . , N)

in the drive transistor,

(A-1) one source/drain region is connected to the m-th feeding line,

(A-2) the other source/drain region is connected to one end of the light emitting portion as well as connected to one electrode of the capacitor unit, which configures a second node, and

(A-3) a gate electrode is connected to the other source/drain region of the write transistor as well as connected to the other electrode of the capacitor unit, which configures a first node,

in the write: transistor,

(B-1) one source/drain region is connected to the n-th data line, and

(B-2) the gate electrode is connected to the m-th scanning line.

The drive method of the display device according to the embodiment of the invention includes the steps of

(a) performing threshold voltage cancel processing at least once, which changes a potential of the second node toward a potential obtained by subtracting a threshold voltage of the drive transistor from a potential of the first node by applying a given drive voltage to one source/drain region of the drive transistor from the feeding line while maintaining the potential of the first node, then,

(b) performing writing processing which applies a video signal to the first node from the data line through the write transistor,

in which the sum of lengths of periods in which the threshold voltage cancel processing is performed is so set as to be shorter as a frame frequency becomes higher.

In the drive method of the display device according to the embodiments, the sum of lengths of periods during which the threshold voltage cancel processing is performed is so set to be shorter as the frame frequency becomes higher. Accordingly, potential difference between the first node and the second node before the step (b) is performed becomes larger as the frame frequency becomes higher. Additionally, potential difference between the first node and the second node after the writing processing also becomes larger as the frame frequency becomes higher, therefore a phenomenon in which the value of the video signal in so-called black display varies according to variations of the frame frequency can be cancelled. Accordingly, it is possible to display pictures in respective frequencies in good condition without adjusting the value of the video signal.

### BRIEF DESCRIPTION OF THE DRAWINGS

FIG. 1 is a conceptual diagram of a display device according to an embodiment;

FIG. 2 is an equivalent circuit diagram of a display element including a drive circuit;

FIG. 3 is a schematic partial cross-sectional view of part of the display device;

FIG. 4 is a schematic view of a timing chart of driving of the display element according to the embodiment;

FIGS. 5A to 5F are diagrams schematically showing an ON/OFF state and the like of respective transistors included in the drive circuit in the display element;

FIGS. 6A to 6F are diagrams schematically showing the ON/OFF state and the like of respective transistors included in the drive circuit in the display element continued from FIG. 5F;

FIG. 7A is a schematic chart for explaining the relation among a potential of a feeling line, a potential of a second node and drain current flowing through the drive transistor.

FIGS. 7B, 7C and 7D are schematic diagrams for explaining the flow of drain current in a period A, a period B and a period C shown in FIG. 7A;

FIG. 8 shows schematic timing charts for explaining the relation between voltage applied to the feeding line and a light emitting period and a non-light emitting period when a frame frequency is 50 Hz and the relation between voltage applied to the feeding line and the light emitting period and the non-light emitting period when the frame frequency is 60 Hz;

FIG. 9A is a schematic chart for explaining a portion which contributes to light emission in the drain current flowing through the drive transistor when the frame frequency is relatively low, and FIG. 9B is a schematic chart for explaining a portion which contributes to light emission in the drain current flowing through the drive transistor when the frame frequency is relatively high;

FIG. 10 is a schematic graph for explaining the relation between the frame frequency and the value of a video signal when the display device starts emitting light in the case where conditions of threshold voltage cancel processing are maintained;

FIG. 11 is a schematic view of a timing chart of driving of the display element when the sum of lengths of periods in which threshold voltage cancel processing is performed is shorted;

FIG. 12 is a schematic chart for explaining a portion which contributes to light emission in the drain current flowing through the drive transistor when the frame frequency is relatively high and the sum of lengths of periods in which the threshold voltage cancel processing is performed is shorted;

FIG. 13 is a schematic configuration diagram for explaining configurations of a power supply unit, a scanning circuit and a control circuit;

FIG. 14A is a schematic circuit diagram for explaining a configuration of part of the scanning circuit corresponding to one scanning line, and FIG. 14B is a schematic circuit diagram for explaining a configuration of part of the power supply unit corresponding to one feeding line;

FIG. 15 is a schematic timing chart for explaining operations in the control circuit, the scanning circuit and the power supply unit;

FIG. 16 is a schematic timing chart for explaining operations in the control circuit, the scanning circuit and the power supply unit;

FIG. 17 is a schematic timing chart for explaining operations in the control circuit, the scanning circuit and the power supply unit;

FIG. 18 is a schematic graph for explaining the relation between the frame frequency and the value of the video signal when the display device starts emitting light in the case where conditions of threshold voltage cancel processing are changed according to the frame frequency;

FIG. 19 is a schematic timing chart for explaining the drive method according to the embodiment when the frame frequency is 50 Hz;

FIG. 20 is a schematic timing chart for explaining the drive method according to the embodiment when the frame frequency is 60 Hz;

FIG. 21 is a schematic timing chart for explaining the drive method according to the embodiment when the frame frequency is 70 Hz;

FIG. 22 is a schematic timing chart for explaining the drive method according to the embodiment when the frame frequency is 80 Hz;

FIG. 23 is a schematic timing chart for explaining the drive method according to the embodiment when the frame frequency is 90 Hz;

FIG. 24 is a schematic timing chart for explaining the drive method according to the embodiment when the frame frequency is 100 Hz;

FIG. 25 is an equivalent circuit diagram of the display element including the drive circuit;

FIG. 26 is an equivalent circuit diagram of the display element including the drive circuit; and

FIG. 27 is an equivalent circuit diagram of the display element including the drive circuit.

### DESCRIPTION OF THE PREFERRED EMBODIMENTS

Hereinafter, the invention will be explained based on an embodiment with reference to the drawings. The explanation will be performed in the following order.

1. Detailed explanation concerning a drive method of a display device according to an embodiment of the invention

2. Explanation of an outline of the display device used in the embodiment

3. Embodiment (Example of a 2Tr/1C drive circuit)

### Detailed Explanation Concerning a Drive Method of a Display Device According to an Embodiment of the Invention

In a display method of a display device according to an embodiment of the invention (also referred to as the embodiment of the invention in the following description), when the display device is driven by a given frame frequency FR in the step (a), it is possible to apply a configuration which satisfies

TU(FR₁)·P(FR₁)>TU(FR₂)·P(FR₂)

in the case where the number of times threshold voltage cancel processing is performed is represented as P(FR), a length of a period during which one threshold voltage cancel processing is performed is represented as TU(FR), a first frame frequency is represented as FR₁ and a second frame frequency which is higher than the first frame frequency is FR₁ is represented as FR₂.

Here, it is preferable to apply a configuration in which a value of TU(FR) is fixed regardless of the frame frequency FR and a value of P(FR) is switched according to a value of the frame frequency FR. It is also preferable to apply a configuration in which the value of P(FR) is fixed regardless of the frame frequency FR and the value of TU(FR) is switched according to the value of the frame frequency FR. These configurations have an advantage that allows the control to be performed easier as any one of values of TU(FR) and P(FR) is switched according to the frame frequency FR. Additionally, it is preferable to apply a configuration in which both values of TR(FR) and P(FR) are switched according the value of the frame frequency FR. The configuration has an advantage that enables more accurate control corresponding to the frame frequency FR to be performed.

According to the embodiment of the invention including the preferred configurations,

pre-processing which initializes a potential of a first node and a potential of a second node is performed,

subsequently, the step (a) and the step (b) are performed,

after that, in a state in which a write transistor is turned off by a scanning signal from a scanning line to make the first node to be in a floating state and a given drive voltage is applied to one source/drain region of a drive transistor from a feeding line, electric current corresponding to a value of potential difference between the first node and the second node is made to flow into a light emitting portion through a drive transistor, thereby driving the light emitting portion.

According to the embodiment of the invention in which the pre-processing is performed,

it is preferable to apply a configuration in which the light emitting portion includes an anode electrode and a cathode electrode, and

potentials of the first node and the second node are so set that the potential difference between a gate electrode and the other source/drain region of the drive transistor exceeds a threshold voltage of the drive transistor as well as that the potential difference between the anode electrode and the cathode electrode of the light emitting portion does not exceed a threshold voltage of the light emitting portion.

According to the embodiment of the invention including various preferred configurations explained above, a current-drive type light emitting portion which emits light by electric current flowing therein can be widely used as the light emitting portion included in the light emitting element. As the light emitting portion, an organic electroluminescence light emitting portion, an inorganic electroluminescence light emitting portion, an LED light emitting portion, a semiconductor laser light emitting portion and the like can be cited. These light emitting portions can be formed by using known materials and methods. The light emitting portion is preferably made of the organic electroluminescence light emitting portion among them from the perspective that a planar display device of color display is configured. The organic electroluminescence light emitting portion may be either a so-called top emission type or a bottom emission type.

Conditions shown in various formulas in the present specification are satisfied not only in the case where formulas are strictly effective mathematically but also in the case where formulas are substantially effective. In other words, various variations generated on design or manufacture of the display element and the display device are allowed concerning effective formulas.

When the potential of the second node reaches a potential obtained by subtracting a threshold voltage of the drive transistor from the potential of the first node by threshold voltage cancel processing, the drive transistor is turned off. On the other hand, when the potential of the second node does not reach the potential obtained by subtracting a threshold voltage of the drive transistor from the potential of the first node, the potential difference between the first node and the second node is larger than the threshold voltage of the drive transistor, and the drive transistor is not turned off. In the drive method according to the embodiment of the invention, potential change of the second node by the threshold voltage cancel processing is reduced as the frame frequency is increased. Therefore, it is basically not necessary that the drive transistor is turned off as a result of the threshold voltage cancel processing.

The writing processing may be performed immediately after the threshold voltage cancel processing is completed or may be performed after a given period of time. Additionally, the writing processing may be performed in a state in which a given drive voltage is applied to one source/drain region of the drive transistor or may be performed in a state in which the given drive voltage is not applied to one source/drain region of the drive transistor. In the former configuration, mobility correction processing is performed together which changes the potential of the other source/drain region of the drive transistor in accordance with characteristics of the drive transistor.

The display device may be configured as a monochrome display or may be configured as a color display. For example, the display device may be configured as the color display, in which one pixel includes plural sub-pixels, specifically, one pixel includes three sub-pixels which are a red-light emitting sub-pixel, a green-light emitting sub-pixel and a blue-light emitting sub-pixel. Furthermore, the pixel may be configured by a set to which one kind or plural kinds of sub-pixels are added to the above three kinds of sub-pixels (one set to which a sub-pixel emitting white light is added for improving luminance, one set to which a sub-pixel emitting a complementary color for expanding the range of reproducing colors, one set to which a sub-pixel emitting yellow for expanding the range of reproducing colors and one set to which sub-pixels emitting yellow and cyan for expanding the range of reproducing colors.

As pixel values of the display device, resolution for displaying pictures can be cited as follows, though it is not limited to these values: VGA (640, 480), S-VGA (800, 600), XGA (1024, 768), APRC (1152, 900), S-XGA (1280, 1024), U-XGA (1600, 1200), HD-TV (1920, 1080) and Q-XGA (2048, 1536) as well as (1920, 1035), (720, 480), (1280, 960) and the like.

In the display device, various wiring such as the scanning line, the data line and the feeding line as well as the light emitting portion can use known configurations and structures. For example, when the light emitting portion is made of the organic electroluminescence light emitting portion, the portion may includes an anode electrode, a hole transporting layer, a light emitting layer, an electron transporting layer, a cathode electrode and the like. Various circuits such as a power supply unit, a scanning circuit, a signal output circuit and a control circuit which are described later can be configured by using known circuit elements and so on.

As a transistor included in the drive circuit, an n-channel thin-film transistor (TFT) can be cited. The transistor included in the drive circuit may be either an enhancement type or a depletion type. In the n-channel transistor, an LDD (Lightly Doped Drain) structure may be formed. The LDD structure may be formed asymmetrically in some cases. For example, large current flows through the drive transistor when the display element emits light, therefore, it is possible to apply a configuration in which the LDD structure is formed only on the side of one source/drain region to be the drain region side at the time of emitting light. Additionally, for example, a p-channel thin-film transistor can be used.

A capacitor unit included in the drive circuit may include one electrode, the other electrode and a dielectric layer (insulating layer) which is sandwiched by these electrodes. The transistor and the capacitor unit included in the drive circuit are formed in a given plane (for example, formed on a base), and the light emitting portion is formed, for example, on an upper portion of the transistor and the capacitor unit included in the drive circuit through an interlayer insulating layer. The other source/drain region is connected to the anode electrode included in the light emitting portion through, for example, a contact hole. It is also preferable to apply a configuration in which the transistor is formed on a semiconductor substrate and the like.

Hereinafter, the invention will be explained based on the embodiment with reference to the drawings, and an outline of a display device used in the embodiment will be explained before the explanation.

### Explanation of an Outline of the Display Device Used in the Embodiment

A display device suitable for being used in the embodiment is a display device including plural pixels. One pixel includes plural sub-pixels (three sub-pixels which are a red-light emitting sub-pixel, a green-light emitting sub-pixel and a blue-light emitting sub-pixel in the embodiment). A current drive-type light emitting portion is configured by an organic electroluminescence light emitting portion. Each sub-pixel includes a display element 10 having a structure in which a drive circuit 11 and a light emitting portion (light emitting portion ELP) connected to the drive circuit 11 are stacked.

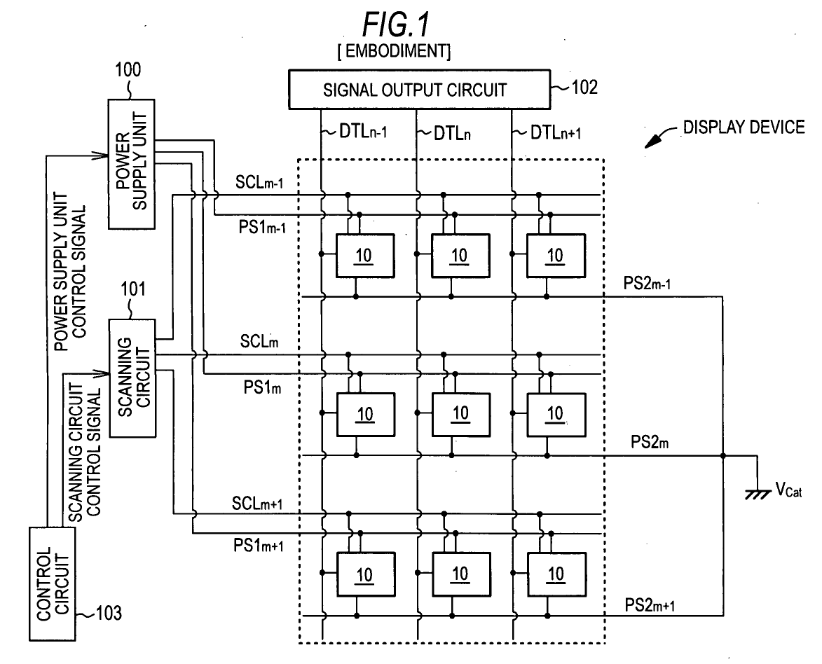

A conceptual diagram used in the embodiment is shown in FIG. 1.

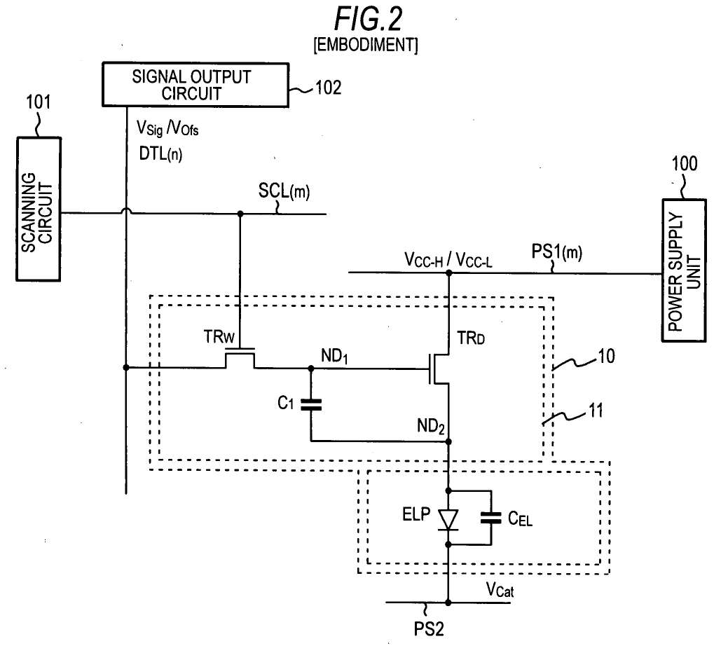

FIG. 2 shows a drive circuit (also referred to as a 2Tr/1C drive circuit) basically including two transistors and one capacitor unit.

As shown in FIG. 1, the display device used in the embodiment includes

(1) the total N×M pieces of display elements 10 in which N-pieces in a first direction and M-pieces in a second direction different from the first direction are arranged in a two-dimensional matrix state, each having the current-drive type light emitting portion ELP and the drive circuit 11,

(2) M-pieces of scanning lines SCL extending in the first direction,

(3) N-pieces of data lines DTL extending in the second direction and

(4) M-pieces of feeding lines PS1 extending in the first direction.

The feeding lines PS1 are connected to the power supply unit 100. The data lines DTL are connected to a signal output circuit 102. The scanning lines SCL are connected to a scanning circuit 101. Though 3×3 pieces of display elements are shown in FIG. 1, it is just exemplification.

The light emitting portion ELP has a known configuration or a structure including, for example, an anode electrode, a hole transporting layer, a light emitting layer, an electron transporting layer, a cathode electrode and the like. Configurations or structures of the scanning circuit 101, the signal line output circuit 102, the scanning line SCL, the data line DTL and the power supply unit 100 can be known configurations or structures. A configuration of a control circuit 103 will be described layer.

The minimum components of the drive circuit 11 are explained. The drive circuit 11 includes at least a drive transistor TR_{D}, a write transistor TR_{W} and a capacitor unit C₁. The drive transistor TR_{D} is configured by an n-channel TFT having source/drain regions, a channel forming region and a gate electrode. The write transistor TR_{W} is also configured by an n-channel TFT having source/drain regions, a channel forming region and a gate electrode. The write transistor TR_{W} may be configured by a p-channel TFT. Additionally, the drive circuit 11 may have further another transistor.

In the drive transistor TR_{D},

(A-1) one source/drain region is connected to the feeding line PS1,

(A-2) the other source/drain region is connected to one end of the light emitting portion ELP (an anode electrode included in the light emitting portion ELP in the embodiment) as well as connected to one of electrodes of the capacitor unit C₁, which configures a second node ND₂, and

(A-3) a gate electrode of the drive transistor TR_{D} is connected to the other source/drain region of the write transistor TR_{W} as well as connected to the other of the capacitor unit C1, which configures a first node ND₁.

More specifically, in the display element 10 of the m-th row (m=1, 2 . . . M) and the n-th column (n=1, 2 . . . N) in the display device shown in FIG. 1, one source/drain region of the drive transistor TR_{D} is connected to the m-th feeling line PS1ₘ.

In the write transistor TR_{W},

(B-1) one source/drain region is connected to the data line DTL, and

(B-2) a gate electrode is connected to the scanning line SCL.

More specifically, in the display element 10 of the m-th row and the n-th column in the display device shown in FIG. 1, one source/drain region of the write transistor TR_{W} is connected to the n-th data line DTLₙ. A gate electrode of the write transistor TR_{W} is connected to the m-th scanning line SCLₘ.

The other end of the light emitting portion ELF (a cathode electrode included in the light emitting portion ELP in the embodiment) is connected to a second feeding line PS2.

More specifically, in the display element 10 of the m-th row and the n-th column in the display device shown in FIG. 1, the cathode electrode included in the light emitting portion ELP is connected to the common second feeding line PS2. The common second feeding line PS2 connected to the display element 10 of the m-th row and the n-th column may be also represented as a common second feeding line PS2ₘ for convenience.

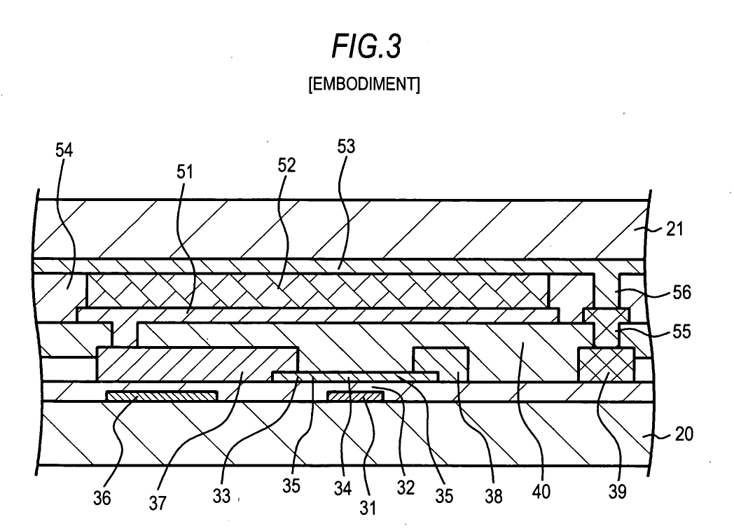

FIG. 3 is a partial cross-sectional view schematically showing part of the display device. The transistors TR_{D}, TR_{W} and the capacitor unit C₁ included in the drive circuit 11 are formed on a base 20, and the light emitting portion ELP is formed, for example, above the transistors TR_{D}, TR_{W} and the capacitor unit C₁ included in the drive circuit 11 through an interlayer insulating layer 40. The other source/drain region of the drive transistors TR_{D} is connected to the anode electrode included in the light emitting portion ELP through a contact hole. In FIG. 3, only the drive transistors TR_{D} is shown. The other transistor is hidden.

More specifically, the drive transistor TR_{D} includes a gate electrode 31, a gate insulating layer 32, source/drain regions 35, 35 provided at a semiconductor layer 33, and a channel forming region 34 corresponding to a portion of the semiconductor layer 33 between the source/drain regions 35, 35. The capacitance unit C₁ is configured by the other electrode 36, a dielectric layer formed by an extended portion of the gate insulating layer 32 and one electrode 37 (corresponding to the second node ND₂). The gate electrode 31, part of the gate insulating layer 32 and the other electrode 36 included in the capacitor unit C₁ are formed on the base 20. One source/drain region 35 of the drive transistor TR_{D} is connected to a wiring 38 and the other source/drain region 35 is connected to one electrode 37. The drive transistor TR_{D}, the capacitor unit C₁ and the like are covered with the interlayer insulating layer 40, and the light emitting portion ELP including an anode electrode 51, a hole transporting layer, a light emitting layer, an electron transporting layer and a cathode electrode 53 is provided on the interlayer insulating layer 40. In the drawing, the hole transporting layer, the light emitting layer and the electron transporting layer are represented by one layer 52. Over a portion of the interlayer insulating layer 40 where the light emitting portion ELP is not provided, a second interlayer insulating layer 54 is provided and a transparent substrate 21 is arranged over the second interlayer insulating layer 54 and the cathode electrode 53. Light emitted at the light emitting layer is transmitted through the substrate 21 and radiated to the outside. One electrode 37 (second node ND₂) and the anode electrode 51 are connected by a contact hole provided in the interlayer insulating layer 40. The cathode electrode 53 is connected to a wiring 39 provided on the extended portion of the gate insulating layer 32 through contact holes 56, 55 provided in the second interlayer insulating layer 54 and the interlayer insulating layer 40.

A method of manufacturing the display device shown in FIG. 3 and the like will be explained. First, various types of wirings such as the scanning line SCL, the electrodes included in the capacitor unit C1, the transistors made of a semiconductor layer, the interlayer insulating layer, the contact holes and the like are suitably formed by a known method. Subsequently, deposition and patterning are performed by known methods and the light emitting portions ELP arranged in a matrix state are formed. After the base 20 and the substrate 21 which have received the above processes are allowed to face each other and the periphery is sealed, wire connection with respect to outside circuits is performed to obtain the display device.

The display device in each embodiment is a color display device including plural display elements 10 (for example, N×M=1920×480). Each display element 10 includes sub-pixels as well as configures one pixel by a group having plural sub-pixels, and pixels are arranged in the two-dimensional matrix state in the first direction and the second direction which is different from the first direction. One pixel includes three kinds of sub-pixels which are the red-light emitting sub-pixel emitting red, the green-light emitting sub-pixel emitting green and the blue-light emitting sub-pixel emitting blue, which are arranged in a direction to which the scanning line SCL extends.

The display device includes (N/3)×M pieces of pixels arranged in the two-dimensional matrix state. The display elements 10 which configure respective pixels are line-sequentially scanned, and a frame frequency (frame rate) is represented as FR (Hz). The display elements 10 configuring respective (N/3) pieces of pixels (N-pieces of sub-pixels) arranged in the m-th row are simultaneously driven. In other words, in respective display elements 10 included in one row, light-emitting/non-light emitting timing is controlled by each row to which these display elements belong. The processing of writing a video signal to respective pixels included in one row may be the processing of writing the video signal to all pixels at the same time (also referred to merely as simultaneous writing processing), or the processing of writing the video signal to respective pixels sequentially (also referred to merely as sequential writing processing). Which writing processing is applied may be appropriately selected according to the configuration of the display device.

As described above, the display elements 10 of the first row to the m-th row are line-sequentially scanned. For convenience of explanation, a period allocated for scanning the display elements 10 of each row is referred to as a horizontal scanning period. In each later-described embodiment, there exist a period in which a first node initialization voltage (later-described V_{0sf}) is applied to the data line DTL (referred to as an initialization period in the following description), subsequently, a period in which the video signal (later-described V_{Sig}) is applied to the data line DTL from the signal output circuit 102 in each horizontal scanning period (referred to as a video signal period).

In principle, drive and operation concerning the display element 10 positioned at the m-th row and the n-th column will be explained, in which the display element 10 is referred to as an (n, m)th display element 10 or an (n, m)th sub-pixel. Then, various processing (threshold voltage cancel processing, writing processing and mobility correction processing) is performed before the horizontal scanning period of respective display elements 10 arranged in the m-th row (the m-th horizontal scanning period) is finished. The writing processing and mobility correction processing are performed during the m-th horizontal scanning period. On the other hand, the threshold voltage cancel processing and accompanying pre-processing are performed before the m-th horizontal scanning period.

After all the above various processing is completed, the light emitting portions. ELP included in respective display elements 10 arranged in the m-th row are allowed to emit light. It is preferable that the light emitting portions ELP are allowed to emit light immediately after all the above various processing is completed, or it is also preferable that the light emitting portions ELP are allowed to emit light after a given period (for example, horizontal scanning periods for the given number of rows) is passed. The given period can be appropriately set in accordance with specifications of the display device, the configuration of the drive circuit and so on. In the following explanation, the light emitting portions ELP are allowed to emit light immediately after various processing is performed for convenience of explanation. The light emitting state of the light emitting portions ELP included in respective display elements 10 arranged in the m-th row is continued just before the start of the horizontal scanning period of respective display elements 10 arranged in the (m+m′)th row. Here, “m′” is determined according to design specifications of the display device. That is, light emission of the light emitting portions ELP included in respective display elements 10 arranged in the m-th row is continued until the (m+m′−1)th horizontal scanning period in a given display frame. On the other hand, the light emitting portions ELP included in respective display elements 10 arranged in the m-th row maintain the non-light emitting state from the beginning of the (m+m′)th horizontal scanning period until the writing processing and the mobility correction processing are completed in the m-th horizontal scanning period in a next display frame in principle. The above period of the non-light emitting state (also referred to merely as a non-light emitting period) is provided, thereby reducing residual image blur due to active matrix drive and allowing the quality of moving pictures to be more excellent. However, the light emitting state and the non-light emitting state of respective sub-pixels (display elements 10) are not limited to the states described above. The time length of the horizontal scanning period is the time length less than (1/FR)×(1/M). When a value of (m+m′) exceeds “M”, the exceeded horizontal scanning period will be processed in the next display frame. In the following description, the frame frequency FR takes various values, however, the time length of the horizontal scanning period is assumed to be fixed to a given value regardless of the frame frequency.

In two source/drain regions included in one transistor, a word “one source/drain region” may be used in a sense of the source/drain region connected to the power supply side. “The transistor is in on-state” indicates a state in which a channel is formed between the source/drain regions. It is no matter whether electric current flows from one source/drain region to the other source/drain region or not. On the other hand, “the transistor is in off-state” indicates a state in which a channel is not formed between the source/drain regions. Additionally, “the source/drain region of a given transistor is connected to the source/drain region of another transistor” includes a form in which the source/drain region of the given transistor and the source/drain region of another transistor occupy the same region. Furthermore, the source/drain regions can be configured by not only conductive materials such as polysilicon or amorphous silicon including impurities but also metal, alloys, conductive particles, a stacked structure of these materials or a layer including organic materials (conductive polymer). In a timing chart used for the following explanation, lengths in a horizontal axis indicating respective periods (time lengths) are schematically shown, which do not indicate the ratio of time lengths in respective periods. It is the same also with respect to a vertical axis. The shape of waveforms in the timing chart is also schematically shown.

Hereinafter, the invention will be explained based on the embodiment.

### Embodiment

The embodiment relates to a drive method of the display device to which the invention is applied.

As shown in FIG. 2, the drive circuit 11 included in the display element 10 includes two transistors, namely, the write transistor TR_{W} and the drive transistor TR_{D}, and one capacitor unit C₁ (2Tr/1C drive circuit). A configuration of the (n, m)th display element 10 will be explained.

### [Drive Transistor Tr_{D}]

One source/drain region of the drive transistor TR_{D} is connected the m-th feeding line PS1ₘ. To one source/drain region of the drive transistor TR_{D}, a given voltage is applied from the m-th feeding line PS1ₘ based on the operation of the power supply unit 100. Specifically, a drive voltage V_{CC-H} and a voltage V_{CC-L} which are later described is supplied from the power supply unit 100. On the other hand, the other source/drain region of the drive transistor TR_{D} is connected to

(1) the anode electrode of the light emitting portion ELP and

(2) one electrode of the capacitor unit C1, which configures the second ND₂. The gate electrode of the drive transistor TR_{D} is connected to

(1) the other source/drain region of the write transistor TR_{W} and

(2) the other electrode of the capacitor unit C1, which configures the first node ND₁.

Here, voltage in the drive transistor TR_{D} is set to be operated in a saturation region when the display element 10 is in the light emitting state, which is driven to allow the drain current I_{ds} to flow in accordance with the following formula (1). In the light emitting state of the display element 10, one source/drain region of the drive transistor TR_{D} functions as a drain region and the other source/drain region functions as a source region. For convenient of explanation, one source/drain region of the drive transistor TR_{D} may be referred to merely as the drain region and the other source/drain region is referred to merely as the source region. In the formula (1),

μ: effective mobility

L: channel length

W: channel width

V_{gs}: potential difference between the gate electrode and the source region

Vₜₕ: threshold voltage

Cₒₓ: (relative permittivity of a gate insulating layer)×(permittivity of vacuum)/(thickness of the gate insulating layer)

k≡(½)·(W/L)·Cₒₓ

I_{ds}=k·μ·(V_{gs}−Vₜₕ)² (1)

The drain current I_{ds} flows through the light emitting portion ELP of the display element 10 to thereby allow the light emitting portion ELP to emit light. Furthermore, the light emitting state (luminance) in the light emitting portion ELP of the display device 10 is controlled according to the size of a value of the drain current I_{ds}.

### [Write Transistor TR_{W}]

The other source/drain region of the write transistor TR_{W} is connected to the gate electrode of the drive transistor TR_{D} as described above. On the other hand, one source/drain region of the write transistor TR_{W} is connected to the n-th data line DTLₙ. To one source/drain region of the write transistor TR_{W}, a given voltage is applied from the n-th data line DTLₙ based on operation of the signal output circuit 102. Specifically, a video signal (drive signal, luminance signal) V_{Sig} for controlling luminance in the light emitting portion ELP and a later-described first node initialization voltage V0_{fs} are supplied from the signal output circuit 102. ON/OFF operation of the write transistor TR_{W} is controlled by a scanning signal from the m-th scanning line SCLₘ connected to the gate electrode of the write transistor TR_{W}, specifically, the scanning signal from the scanning circuit 101.

### [Light Emitting Portion ELP]

The anode electrode of the light emitting portion ELP is connected to the source region of the drive transistor TR_{D} as described above. On the other hand, the cathode electrode of the light emitting portion ELP is connected to the m-th second feeling line PS2ₘ. To the cathode electrode of the light emitting portion ELP, a later-described given voltage V_{Cat} is applied from the m-th second feeling line PS2ₘ. A capacitor of the light emitting portion ELP is represented by a code C_{EL}. A threshold voltage necessary for light emission of the light emitting portion ELP is represented by V_{th-EL}. That is, when voltage equal to or more than V_{th-EL} is applied between the anode electrode and the cathode electrode of the light emitting portion ELP, the light emitting portion ELP emits light.

Next, the display device and the drive method thereof according to the embodiment will be explained.

In the following description, values of voltage or potential will be represented as follows. These are just values for explanation and they are not limited to these values.

V_{Sig}: a video signal for controlling luminance in the light emitting portion ELP . . . 1V (black display) to 8V (white display)

V_{CC-H}: drive voltage for allowing current to flow through the light emitting portion ELP . . . 20V

V_{CC-L}: second initialization voltage . . . −10V

V_{0fs}: first node initialization voltage for initializing a potential of the gate electrode of the drive transistor TR_{D} (potential of the first node ND₁) . . . 0V

Vₜₕ: threshold voltage of the drive transistor TR_{D} . . . 3V

V_{Cat}: voltage applied to the cathode electrode of the light emitting portion ELP . . . 0V

V_{th-EL}: threshold voltage of the light emitting portion ELP . . . 3V

The drive method of the display device according to the embodiment includes the steps of

(a) performing threshold voltage cancel processing at least once, which changes a potential of the second node ND₂ toward a potential obtained by subtracting the threshold voltage Vₜₕ of the drive transistor TR_{D} from a potential of the first node ND₁ by applying a given drive voltage V_{CC-H} to one source/drain region of the drive transistor TR_{D} from the feeding line PS1ₘ while maintaining the potential of the first node ND₁, then,

(b) performing writing processing which applies the video signal V_{Sig} to the first node ND₁ from the data line DTLₙ through the write transistor TR_{W}.

In the embodiment, pre-processing for initializing the potential of the first node ND₁ and the potential of the second node ND₂ is performed. Next, the above step (a) and step (b) are performed. After that, the write transistor TR_{W} is turned off based on a scanning signal from the scanning line SCL to thereby allow the first node ND₁ to be in a floating state. Electric current corresponding to a value of the potential difference between the first node ND₁ and the second node ND₂ is allowed to flow into the light emitting portion ELP through the drive transistor TR_{D} in a state in which the given drive voltage V_{CC-H} is applied to one source/drain region of the drive transistor TR_{D} from the feeling line PS1, which drives the light emitting portion ELP.

As described above, the light emitting portion ELP includes the anode electrode and the cathode electrode. The pre-processing is a step for setting the potential of the first node ND₁ and the potential of the second node ND₂ so that the voltage difference between the gate electrode and the other source/drain region of the drive transistor TR_{D} exceeds the threshold voltage Vₜₕ of the drive transistor TR_{D} as well as the potential difference between the anode potential and the cathode potential of the light emitting portion ELP does not exceed the threshold voltage V_{th-EL} of the light emitting portion ELP.

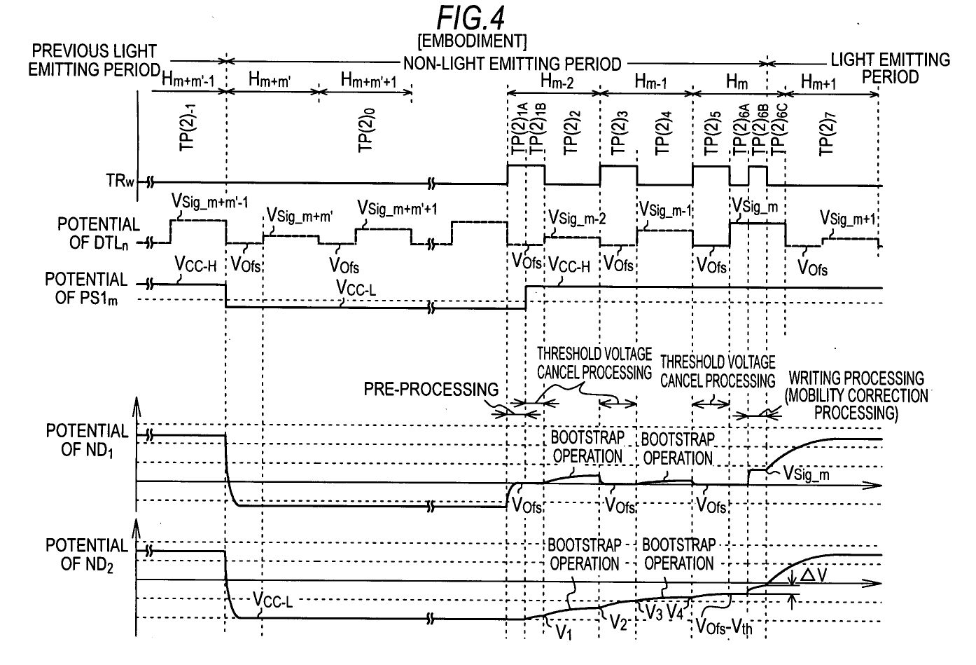

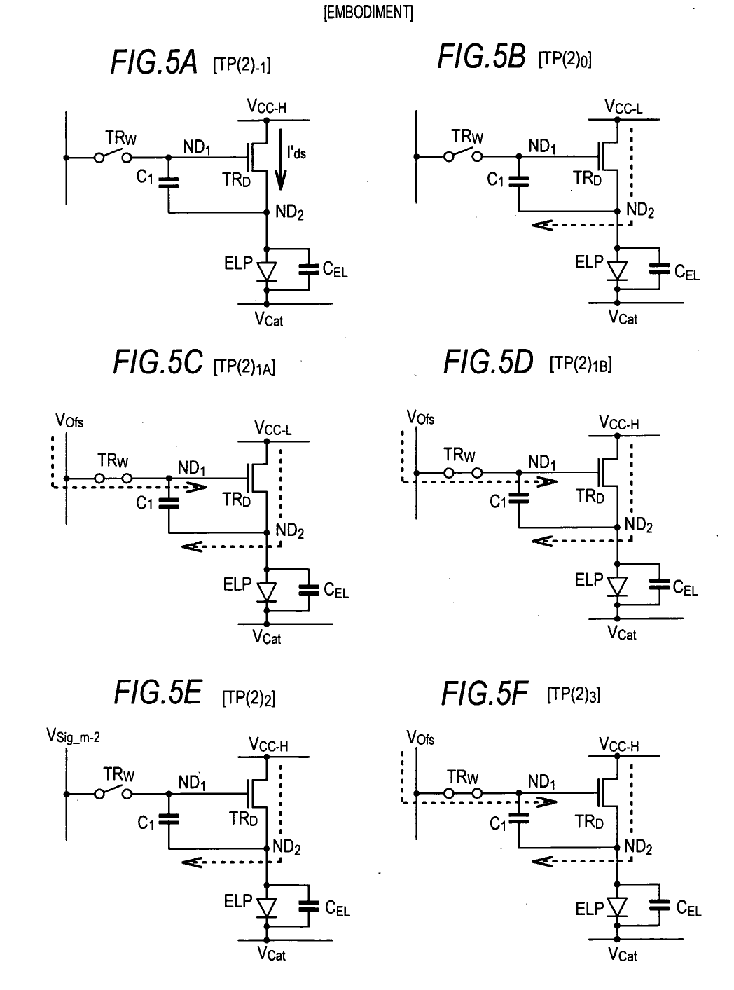

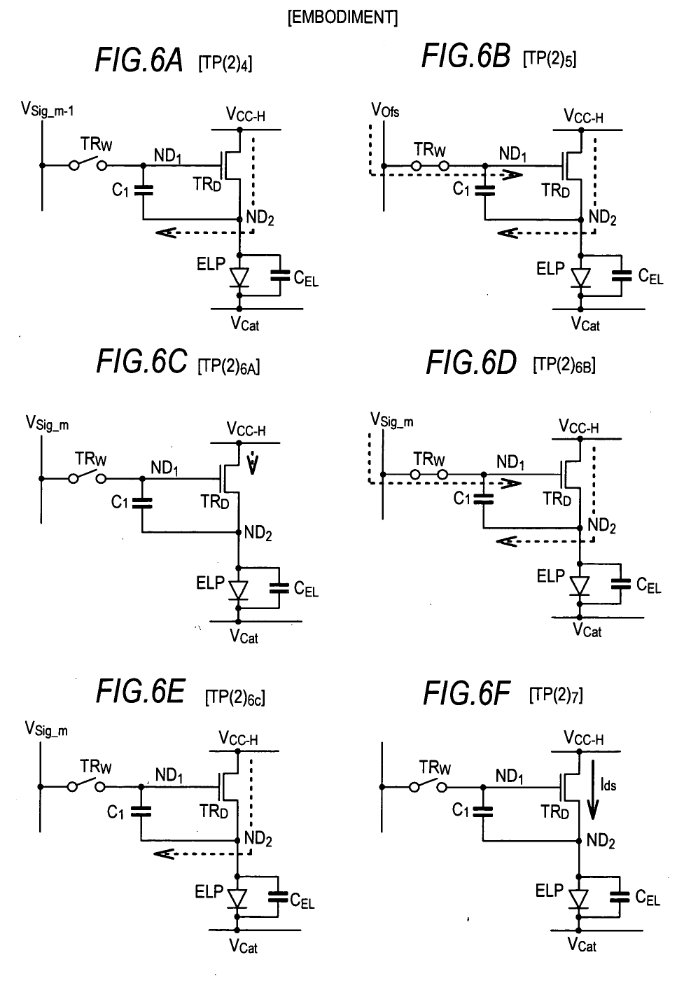

In the embodiment, the threshold cancel processing is performed plural times over plural scanning periods. First, a basic principle in the drive method of the display device according to the embodiment will be explained for helping understanding of the invention. A timing chart of driving of the display element 10 is schematically shown in FIG. 4, and an ON/OFF state and the like of respective transistors of the display element 10 are schematically shown in FIGS. 5A to 5F and FIGS. 6A to 6F.

For convenience of explanation, in operations shown in FIG. 4, explanation will be made assuming that the threshold voltage cancel processing is performed over the (m−2)th horizontal scanning period Hₘ₋₂ to the m-th horizontal scanning period Hₘ. Actually, the threshold voltage cancel processing is performed over further longer horizontal periods.

### [Period-TP(2)₋₁] (Refer to FIG. 4 and FIG. 5A)

[Period-TP(2)₋₁] is, for example, an operation in a previous display frame, which is a period in which the (n, m)th display element 10 is in the light emitting state after various previous processing has been completed. That is, a drain current I′_{ds} based on a later-described formula (5′) flows through the light emitting portion ELP in the display element 10 forming the (n, m)th sub-pixel and luminance of the display element 10 forming the (n, m)th sub-pixel is a value corresponding to the drain current I′_{ds}. Here, the write transistor TR_{W} is in the off state and the drive transistor TR_{D} is in the on-state. The (n, m)th light emitting state of the is continued to just before the horizontal scanning period of the display element 10 arranged in the (m+m′)th row.

The first initialization voltage V_{0fs} and the video signal V_{Sig} is applied to the data line DTLₙ so as to correspond to each horizontal scanning period. However, the write transistor TR_{W} is in the off-state, therefore, the potentials of the first node N₁ and the second node ND₂ do not change even when the potential (voltage) of the data line DTLₙ changes in [Period-TP(2)₋₁] (actually, potential change due to capacitive coupling such as parasitic capacitance and so on may occur, but these can be ignored). It is the same with respect to later-described [Period-TP(2)₀]

A period from [Period-TP(2)₀] to [Period-TP(2)_{6A}] shown in FIG. 4 is an operation period from the light emitting state after the various previous processing has been completed to just before the next writing processing is performed. In a period from [Period-TP(2)₀] to [Period-TP(2)_{6B}], the (n, m)th display element 10 is in the non-light emitting state in principle. As shown in FIG. 4, in addition to [Period-TP(2)₅] and [Period-TP(2)_{6A}], [Period-TP(2)_{6B}] and [Period-TP(2)_{6c}] are included in the m-th horizontal scanning period Hₘ.

For convenience of explanation, the beginning of [Period-TP(2)_{1A}] is assumed to correspond to the beginning of an initialization period in the (m−2)th horizontal scanning period Hₘ₋₂ (a period in which the potential of the data line DTLₙ is V_{0fs} in FIG. 4, which is the same with respect to other horizontal scanning periods). Similarly, the end of [Period-TP(2)_{1B}] is assumed to correspond to the end of the initialization period in the horizontal scanning period Hₘ₋₂. Also, the beginning of [Period-TP(2)₂] is assumed to correspond to the beginning of a video signal period in the horizontal scanning period Hₘ₋₂ (the period in which the potential of the data line DTLₙ is the video signal V_{Sig} in FIG. 4, which is the same with respect to other horizontal scanning periods).

Hereinafter, respective periods of [Period-TP(2)₀] to [Period-TP(2)₇] will be explained. The beginning of the [Period-TP(2)_{1B}] and lengths of respective periods of [Period-TP(2)_{6A}] to [Period-TP(2)_{6c}] may be appropriately set according to design of the display element and the display device.

### [Period-TP(2)₀] (Refer to FIG. 4 and FIG. 5B)

[Period-TP(2)₀] is, for example, an operation from the previous display frame to the current display frame. That is, [Period-TP(2)₀] is a period from the beginning of the (m+m′)th horizontal scanning period H_{m+m′} in the previous display frame to the (m−3)th horizontal scanning period in the current display frame. In [Period-TP(2)₀], the (n, m)th display device 10 is in the non-light emitting state in principle. At the beginning of [Period-TP(2)₀], the voltage supplied to the feeding line PS1ₘ from the power supply unit 100 is switched from the drive voltage drive voltage V_{CC-H} to the second node initialization voltage V_{CC-L}. As a result, the potential of the second node ND₂ is reduced to V_{CC-L}, reverse-direction voltage is applied between the anode electrode and the cathode electrode of the light emitting portion ELP, and the light emitting portion ELP becomes in the non-light emitting state. The potential of the first node ND₁ in the floating state (gate electrode of the drive transistor TR_{D}) is also reduced in accordance with the potential reduction of the second node ND₂.

### [Period-TP(2)_{1A}] (Refer to FIG. 4 and FIG. 5C)

Then, the (m−2)th horizontal scanning period Hₘ₋₂ in the current display frame is started. In [Period-TP(2)_{1A}], pre-processing is performed.

As described above, in respective horizontal scanning periods, the first node initialization voltage V_{0fs} is applied to the data line DTLₙ from the signal output circuit 102, subsequently, the video signal V_{Sig} is applied instead of the first node initialization voltage V_{0fs}. More specifically, the first node initialization voltage V_{0fs} is applied to the data line DTLₙ, subsequently, a video signal corresponding to the (n, m−2)th sub-pixel (represented as V_{Sig}_{_{—}}ₘ₋₂ for convenient. It is the same with respect to other video signals) is applied instead of the first node initialization voltage V_{0fs}, corresponding to the (m−2)th horizontal scanning period Hₘ₋₂ in the current display frame. It is the same with respect to other horizontal scanning periods. Though not shown in FIG. 4, the first initialization voltage V_{0fs} and the video signal V_{Sig} are applied to the data line DTLₙ in respective horizontal scanning periods other than the horizontal scanning periods Hₘ₋₂, Hₘ₋₁, Hₘ, H_{m+1′}, H_{m+m′-1′}, and H_{m+m′}.

Specifically, the scanning line SCLₘ is made high in level at the beginning of [Period-TP(2)_{1A}], thereby turning on the write transistor TR_{W}. The voltage applied to the data line DTLₙ from the signal output circuit 102 is V_{ofs} (initialization period). As a result, the potential of the first node ND₁ will be V_{ofs} (0V). Since the second node initialization voltage V_{CC-L} is applied to the second node ND₂ from the feeding line PS1ₙ, based on operation of the power supply unit 100, the potential of the second node ND₂ is maintained to V_{CC-L} (−10V).

The voltage difference between the first node ND₁ and the second node ND₂ is 10V, and the threshold voltage Vₜₕ of the drive transistor TR_{D} is 3V, therefore, the drive transistor TR_{D} is in on-state. The voltage difference between the second node ND₂ and the cathode electrode included in the light emitting portion ELP is −10V, which does not exceed the threshold voltage V_{th-EL} of the light emitting portion ELP. Accordingly, the pre-processing which initializes the potential of the first node ND₁ and the potential of the second node ND₂ is completed.

When the pre-processing is performed, it is preferable to apply a configuration in which the write transistor TR_{W} is turned on after waiting for the voltage applied to the data line DTLₙ to be switched to the first node initialization voltage V_{0fs}. Additionally, it is also possible to apply a configuration in which the write transistor TR_{W} is turned on by the signal from the scanning line before the beginning of the horizontal scanning period in which the pre-processing is performed. According to the latter configuration, the potential of the first node ND₁ is initialized immediately after the first node initialization voltage V_{0fs} is applied to the data line DTLₙ. According to the former configuration in which the write transistor TR_{W} is turned on after waiting for the voltage applied to the data line DTLₙ to be switched to the first node initialization voltage V_{0fs}, it is necessary to allocate time to the pre-processing including time of waiting for the switching. On the other hand, according to the latter configuration, the time of waiting for the switching is not necessary and the pre-processing can be performed in a short time.

Next, the above-described step (a), namely, the threshold voltage cancel processing is performed over a period from [Period-TP(2)_{1B}] to [Period-TP(2)₅]. Specifically, the first threshold voltage-cancel processing is performed in [Period-TP(2)_{1B}], the second threshold voltage cancel processing is performed in [Period-TP(2)₃], and the third threshold voltage cancel processing is performed in [Period-TP(2)₅].

### [Period-TP(2)_{1B}] (Refer to FIG. 4, FIG. 5D]

That is, the voltage supplied to the feeding line PS1ₘ from the power supply unit 100 is switched from the voltage V_{CC-L} to the drive voltage V_{CC-H} while maintaining on-state of the write transistor TR_{W}. As a result, the potential of the first node ND₁ does not change (maintaining V_{0fs}=0V), however, the potential of the second node ND₂ is changed toward a potential obtained by subtracting the threshold voltage Vₜₕ of the drive transistor TR_{D} from the potential of the first node ND₁. That is, the potential of the second node ND₂ is increased.

When [Period-TP(2)_{1B}] is sufficiently long, the potential difference between the gate electrode and the other source/drain region of the drive transistor TR_{D} reaches Vₜₕ, and the drive transistor TR_{D} is turned off. That is, the potential of the second node ND₂ becomes close to (V_{0fs}−Vₜₕ) and finally reaches (V_{0fs}−Vₜₕ). However, in the example shown in FIG. 4, the length of [Period-TP(2)_{1B}] is not sufficiently long for sufficiently changing the potential of the second node ND₂, and the potential of the second node ND₂ reaches a given potential V₁ which satisfies the relation of V_{CC-H}<Vᵢ<(V_{0fs}−Vₜₕ) at the end of [Period-TP(2)_{1B}].

### [Period-TP(2)₂] (Refer to FIG. 4, FIG. 5E)

At the beginning of [Period-TP(2)₂], the potential of the data line DTLₙ is switched from the first node initialization voltage V_{0fs} to the video signal V_{Sig}_{_{—}}ₘ₋₂. The write transistor TR_{W} is turned off by the signal from the scanning line SCLₙ, at the beginning of [Period-TP(2)₂] so that the video signal V_{Sig}_{_{—}}ₘ₋₂ is not applied to the first node ND₁. As a result, the first node ND₁ is in the floating state.

Since the drive voltage V_{CC-H} is applied to one source/drain region of the drive transistor TR_{D} from the power supply unit 100, therefore, the potential of the second node ND₂ is increased from the potential V₁ to a given potential V₂. On the other hand, since the gate electrode of the drive transistor TR_{D} is in the floating state and there exists the capacitor unit C₁, a bootstrap operation is generated at the gate electrode of the drive transistor TR_{D}. Accordingly, the potential of the first node ND₁ is increased in accordance with the potential change of the second node ND₂.

### [Period-TP(2)₃] (Refer to FIG. 4, FIG. 5F)

At the beginning of [Period-TP(2)₃], the potential of the data line DTLₙ is switched from the video signal V_{Sig}_{_{—}}ₘ₋₂ to the first node initialization voltage V_{0fs}. At the beginning of [Period-TP(2)₃], the write transistor TR_{W} is turned on by the signal from the scanning line SCLₘ. As a result, the potential of the first node ND₁ will be V_{0fs}. The drive voltage V_{CC-H} is applied to one source/drain region of the drive transistor TR_{D} from the power supply unit 100. As a result, the second ND₂ is changed toward a potential obtained by subtracting the threshold voltage Vₜₕ of the drive transistor TR_{D} from the potential of the first node ND₁. That is, the potential of the second ND₂ is increased from the potential V₂ to a given potential V₃.

### [Period-TP(2)₄] (Refer to FIG. 4, FIG. 6A)

At the beginning of [Period-TP(2)₄], the potential of the data line DTLₙ is switched from the first node initialization voltage V_{0fs} to the video signal V_{Sig}_{_{—}}ₘ₋₁. The write transistor TR_{W} is turned off by the signal from the scanning line SCLₘ at the beginning of [Period-TP(2)₄] so that the video signal V_{Sig}_{_{—}}ₘ₋₁ is not applied to the first node ND₁. As a result, the first node ND₁ is in the floating state.

Since the drive voltage V_{CC-H} is applied to one source/drain region of the drive transistor TR_{D} from the power supply unit 100, therefore, the potential of the second node ND₂ is increased from the potential V₃ to a given potential V₄. On the other hand, since the gate electrode of the drive transistor TR_{D} is in the floating state and there exists the capacitor unit C₁, the bootstrap operation is generated at the gate electrode of the drive transistor TR_{D}. Accordingly, the potential of the first node ND₁ is increased in accordance with the potential change of the second node ND₂.

As a prerequisite of an operation in [Period-TP(2)₅], it is necessary that the potential V₄ of the second node ND₂ is lower than (V_{0fs}−Vₜₕ) at the beginning of [Period-TP(2)₅]. The length from the beginning of [Period-TP(2)_{1B}] to the beginning of [Period-TP(2)₅] is determined to satisfy a condition of V4<((V_{0fs-L}−Vₜₕ).

### [Period-TP(2)₅] (Refer to FIG. 4, FIG. 6B)

An operation of [Period-TP(2)₅] is basically the same as the operation explained in [Period-TP(2)₃]. At the beginning of [Period-TP(2)₅], the potential of the data line DTLₙ is switched from the video signal V_{Sig}_{_{—}}ₘ₋₁ to the first node initialization voltage V_{0fs}. The write transistor TR_{W} is turned on by the signal from the scanning line SCLₘ at the beginning of [Period-TP(2)₅].

The first node ND₁ is in a state in which the first node initialization voltage V_{0fs} is applied from the data line DTLₙ through the write transistor TR_{W}. Since drive voltage V_{CC-H} is applied to one source/drain region of the drive transistor TR_{D} from the power supply unit 100, the potential of the second node ND₂ is changed toward a potential obtained by subtracting the threshold voltage Vₜₕ of the drive transistor TR_{D} from the potential of the first node ND₁ in the same manner as explained in [Period-TP(2)₃]. Then, when the potential difference between the gate electrode and the other source/drain region of the drive transistor TR_{D} reaches Vₜₕ, the drive transistor TR_{D} is turned off. In this state, the potential of the second node ND₂ is almost (V_{0fs}−Vₜₕ). Here, when the following (2) is certified, in other words, when the potential is selected and determined to satisfy the formula (2), the light emitting portion ELP does not emit light.

(V_{0fs}−Vₜₕ)<(V_{th-EL}+V_{Cat}) (2)

In [Period-TP(2)₅], the potential of the second node ND₂ will be (V_{0fs}−Vₜₕ) finally. That is, the potential of the second node ND₂ is determined only depending on the threshold voltage Vₜₕ of the drive transistor TR_{D} and the voltage V_{0fs} for initializing the potential of the gate electrode of the drive transistor TR_{D}. Then, the potential of the second node ND₂ has no relation to the threshold voltage V_{th-EL} of the light emitting portion ELP.

### [Period-TP(2)_{6A}] (Refer to FIG. 4, FIG. 6C)

At the beginning of [Period-TP(2)_{6A]}, the write transistor TR_{W} is turned off by the scanning signal from the scanning line SCLₘ. The voltage to be applied to the data line DTLₙ is switched from the first node initialization voltage V_{0fs} to the video signal V_{Sig}_{_{—}}ₘ (video signal period). When the drive transistor TD_{R} reaches the off-state in the threshold voltage cancel processing, potentials of the first node ND₁ and the ND₂ do not change. When the drive transistor TD_{R} does not reach the off-state in the threshold voltage cancel processing performed in [Period-TP(2)₅], the bootstrap operation is generated in [Period-TP(2)_{6A}] and potentials of the first node ND₁ and the ND₂ are increased to some degree.

### [Period-TP(2)_{6B}] (Refer to FIG. 4, FIG. 6D)

In this period, the above step (b), namely, writing processing is performed. The write transistor TR_{W} is turned on by the scanning signal from the scanning line SCLₘ. Then, the video signal V_{Sig}_{_{—}}ₘ, is applied to the first node ND₁ from the data line DTLₙ through the write transistor. TR_{W}. As a result, the potential of the first node ND₁ is increased to V_{Sig}_{_{—}}ₘ. The drive transistor TD_{R} is in on-state. It is also possible to apply a configuration in which the write transistor TR_{W} maintains on-state in [Period-TP(2)_{6A}] in some cases. In the configuration, writing processing is stated immediately after the voltage of the data line DTLₙ is switched from the first node initialization voltage V_{0fs} to the video signal V_{Sig}_{_{—}}ₘ. This is also the same in a later-described embodiment.

Here, a value of the capacitor unit C₁ is represented as “c₁” and a value of the capacitor C_{EL} of the light emitting portion ELP is represented as c_{EL}. Then, a value of a capacitor between the gate electrode and the other source/drain region of the drive transistor TR_{D} is represented as c_{gs}. When a capacitance value between the first node ND₁ and the second node ND₂ is represented as a code c_{A}, c_{A}=c₁+c_{gs}. When a capacitance value between the second node ND₂ and the second feeding line PS2 is represented as a code c_{B}, c_{B}=c_{EL}. A configuration in which additional capacitor units are connected in parallel to both ends of the light emitting portion ELP can be applied, and capacitance values of the additional capacitor units are further added to c_{B}.

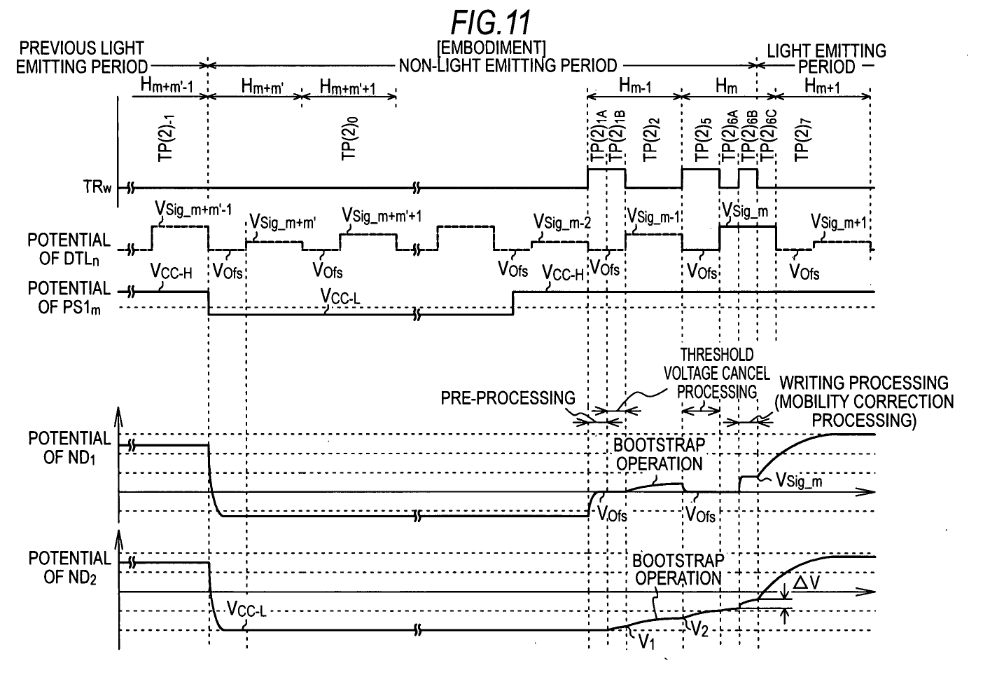

When the potential of the gate electrode of the drive transistor TR_{D} is changed from V_{0fs} to V_{Sig-m} (>_{0fs}), the potential between the first node ND₁ and the second node ND₂ is changed. That is, a charge based on a changed amount (V_{Sig}_{_{—}}ₘ−V_{0fs}) of the potential of the gate electrode of the drive transistor TR_{D} (=the potential of the first node ND₁) is distributed according to the capacitance value between the first node ND₁ and the second node ND₂ and the capacitance value between the second node ND₂ and the feeding line PS2. Therefore, when a value cₛ (=c_{EL}) is a sufficiently large as compared with a value c_{A} (c₁+c_{gs}), the change of the potential of the second node ND₂ is small. In general, the value c_{EL} of the capacitor C_{EL} of the light emitting portion ELP is larger than the value c₁ of the capacitor unit C₁ and the value c_{gs} which is parasitic capacitance of the drive transistor TR_{D}. Hereinafter, explanation will be made, not considering potential change of the second node ND₂ generated by potential change of the first node ND₁ for convenience. The timing chart concerning the drive shown in FIG. 4 is shown without considering potential change of the second node ND₂ generated by potential change of the first node ND₁. It is also the same with respect to FIG. 11 which will be referred to.

In the above-described writing processing, the video signal V_{Sig}_{_{—}}ₘ is applied to the gate electrode of the drive transistor TR_{D} in the state in which the drive voltage V_{CC-H} is applied to one source/drain region of the drive transistor TR_{D} from the power supply unit 100. Accordingly, the potential of the second node ND₂ is increased in [Period-TP(2)_{6B}] as shown in FIG. 4. The increased amount of the potential (ΔV shown in FIG. 4) will be described later. When the potential of the gate electrode of the drive transistor TR_{D} (first node ND₁) is represented by V_{g}, and the potential of the other source/drain regions of the drive transistor TR_{D} is represented as Vₛ, values of V_{g}, Vₛ will be as follows if the potential increase of the second node ND₂ is not considered. The potential difference between the first node ND₁ and the second ND₂, namely, the potential difference V_{gs} between the gate electrode of the drive transistor TR_{D} and the other source/drain region functioning as a source region can be represented by the following formula (3).

V_{g}−V_{Sig}_{_{—}}ₘ

Vₛ≅V_{0fs}−Vₜₕ

V_{gs}≅V_{Sig}_{_{—}}ₘ−(V_{0fs}−Vₜₕ) (3)

That is, V_{gs} obtained in the writing processing with respect to the drive transistor TR_{D} depends only on the video signal V_{Sig}_{_{—}}ₘ for controlling the luminance in the light emitting portion ELP, the threshold voltage Vₜₕ of the drive transistor TR_{D} and the voltage V_{ofs} for initializing the potential of the gate electrode of the drive transistor TR_{D}. Additionally, V_{gs} has no relation to a threshold voltage V_{th-EL} of the light emitting portion ELP.

Subsequently, the above-described potential increase of the second node ND₂ in [Period-TP(2)_{6B}] will be explained. In the above drive method, mobility correction processing which increases the potential of the other source/drain region (namely, the potential of the second node ND₂) in accordance with characteristics of the drive transistor TR_{D} (for example, the size of the mobility μ and the like) is performed together in the writing processing.

In the case where the drive transistor TR_{D} is made of a polysilicon thin-film transistor and so on, it is difficult to avoid occurrence of variations in the mobility μ among transistors. Therefore, when the video signal V_{Sig} of the same value is applied to the gate electrodes of plural drive transistors TR_{D} having different mobilities μ, difference occurs between the drain current I_{ds} flowing through the drive transistor TR_{D} having large mobility μ and the drain current I_{ds} flowing through the drive transistor TR_{D} having small mobility μ. When such difference occurs, uniformity of the screen in the display device is reduced.

In the above drive method, the video signal V_{Sig}_{_{—}}ₘ is applied to the gate electrode of the drive transistor TR_{D} in the state in which the drive voltage V_{CCH} is applied to one source/drain regions of the drive transistor TR_{D} from the power supply unit 100. Accordingly, the potential of the second node ND₂ is increased in [Period-TP(2)_{6B}] as shown in FIG. 4. When the value of the mobility μ of the drive transistor TR_{D} is large, the increased amount ΔV (potential correction value) of the potential in the other source/drain region of the drive transistor TR_{D} (namely, the potential of the second node ND₂) is increased. On the other hand, when the value of the mobility μ of the drive transistor TR₁ is small, ΔV (potential correction value) of the potential in the other source/drain region of the drive transistor TR₁, is reduced. Here, the potential difference V_{gs} between the gate electrode of the drive transistor TR_{D} and the other source/drain region functions as the source region can be transformed from the formula (3) into the following formula (4).

V_{gs}≅V_{Sig}_{_{—}}ₘ−(V_{0fs}−Vₜₕ)−ΔV (4)

Full time (t₀) of given time for executing the writing processing ([Period-TP(2)_{6B}] in FIG. 4) may be determined according to design of the display element and the display device. The full time tₒ of [Period-TP(2)_{6B}] is determined so that the potential (V_{0fs}−Vₜₕ)+ΔV) in the other source/drain region of the drive transistor TR_{D} at this time satisfies the following formula (2′). The light emitting portion ELP does not emit light in [Period-TP(2)_{6B}]. According to the mobility correction processing, correction of variations in a coefficient “k” (≡½)·(W/L)·C_{Ox}) is performed at the same time.

(V_{0fs}−Vₜₕ)+ΔV)<(V_{th-EL}+V_{Cat}) (2′)

[Period-TP(2)_{6c}] (Refer to FIG. 4, FIG. 6E)

According to the above operation, the steps (a), (b) are completed. After that, the following step is performed from [Period-TP(2)_{6C}]. That is, while maintaining the state in which the drive voltage V_{CC-H} is applied to one source/drain region of the drive transistor TR_{D} from the power supply unit 100, the scanning line SCLₘ is made low in level, the write transistor TR_{W} is turned off and the first node ND₁, namely, the gate electrode of the drive transistor TR_{D} is made in the floating state. Accordingly, as a result of the above, the potential of the second node ND₂ is increased.

As described above, the gate electrode of the drive transistor TR_{D} is in the floating state as well as there exists the capacitor unit C1, therefore, a phenomenon similar to the phenomenon in a so-called bootstrap circuit is generated at the gate electrode of the drive transistor TR_{D} and the potential of the first node ND₁ is also increased. As a result, the potential difference V_{gs} between the gate electrode of the drive transistor TR_{D} and the other source/drain region functions as the source region maintains the value of the formula (4).

Since the potential of the second node ND₂ is increased and exceeds (V_{th-EL}+V_{Cat}), the light emitting portion ELP starts emitting light (refer to FIG. 6F). At this time, electric current flowing into the light emitting portion ELP is the drain current I_{ds} flowing from the drain region to the source region of the drive transistor T_{RD}, therefore, it can be represented by the formula (1). Here, the formula (1) can be transformed into the following formula (5) from the formula (1) and the formula (4).

I_{ds}=k·μ·(V_{Sig}_{_{—}}ₘ−V_{0fs}−ΔV)² (5)

Therefore, for example, when V_{0fs} is set to 0V, the current I_{ds} flowing through the light emitting portion ELP is in proportion to a square of a value obtained by subtracting a value of the potential correction value ΔV due to the mobility μ of the drive transistor T_{RD} from a value of the video signal V_{Sig}_{_{—}}ₘ for controlling the luminance in the light emitting portion ELP. In other words, the current I_{ds} flowing through the light emitting portion ELP does not depend on the threshold voltage V_{th-EL} of the light emitting portion. ELP and the threshold voltage Vₜₕ of the drive transistor TR_{D}. That is, the light emitting amount (luminance) of the light emitting portion ELP is not affected by the threshold voltage V_{th-EL} of the light emitting portion ELP and the threshold voltage Vₜₕ of the drive transistor TR_{D}. The luminance of the (m, n)th display element 10 has a value corresponding to such current I_{ds}.

The larger the mobility μ of the drive transistor TR_{D} is, the larger the potential correction value ΔV becomes, therefore, the value of V_{gs} in the left side of the formula (4) is reduced. Therefore, the value of (V_{Sig}_{_{—}}ₘ−V_{0fs}−ΔV)² is reduced even when the value of the mobility μ is large in the formula (5), as a result, it is possible to correct variations of the drain current I_{ds} due to variations of the mobility μ of the drive transistor TR_{D} (further, variations of “k”). Accordingly, variations of the luminance of the light emitting portion ELP due to variations of the mobility μ (further, variations of “k”) can be corrected.

Then, the light emitting state is continued to the (m+m′−1)th horizontal scanning period. The end of the (m+m′−1)th horizontal scanning period corresponds to the end of [Period-TP(2)₋₁]. Here, “m′” is a given value in the display device which satisfies the relation of 1<m′<M. In other words, the light emitting portion ELP is driven from the beginning of [Period-TP(2)_{6C}] to just before the (m+m′)th horizontal scanning period H_{m+m′}, and this period corresponds to the light emitting period.

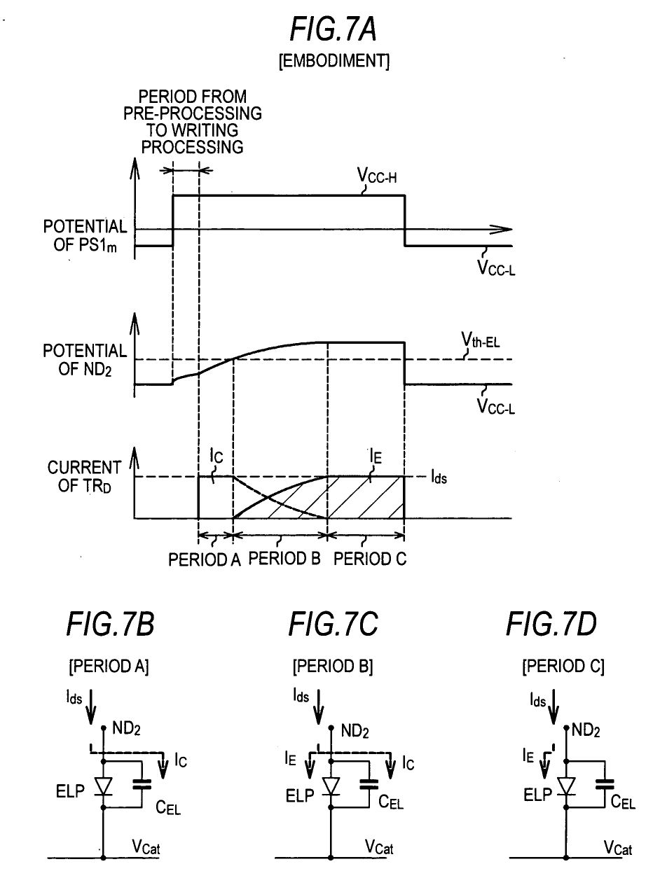

The relation among the potential of the feeding line PS1, the potential of the second node ND₂ and the drain current I_{ds} flowing through the drive transistor TR_{D} will be explained with reference to FIGS. 7A to 7D.

As shown in FIG. 7A, when the potential of the feeling line PS1ₘ is switched from the second node initialization voltage V_{CC-L} to the drive voltage V_{CC-H}, the drain current I_{ds} flows through the drive transistor TR_{D} except the period from the pre-processing to the writing processing explained with reference to FIG. 4. Therefore, the potential of the second node ND₂ is increased after the writing processing is completed.

At this time, in a period “A” during which the potential of the second node ND₂ does not exceed the threshold voltage V_{th-EL} of the light emitting portion ELP, the drain current I_{ds} exclusively flows into the capacitor C_{EL} of the light emitting portion ELP (refer to FIG. 7B). A code I_{C} denotes current flowing into the capacitor C_{EL} in the drain current I_{ds}, and a code I_{E} denotes current flowing into the light emitting portion ELP in the drain current I_{ds}. In a period “B” during which the potential of the second node ND₂ reaches a fixed value after exceeding the threshold voltage V_{th-EL} of the light emitting portion ELP, the drain current I_{ds} flows into the capacitor C_{EL} as well as flows into the light emitting portion ELP (refer to FIG. 7C). Furthermore, in a period “C” after the potential of the second node ND₂ reaches the fixed value, the drain current I_{ds} exclusively flows into the light emitting portion ELP (refer to FIG. 7D). The current I_{C} flowing into the capacitor C_{EL} does not contribute to the light emission. Therefore, part of the drain current I_{ds} which contributes to the light emission (charge amount) is a portion to which hatching is performed in FIG. 7A.

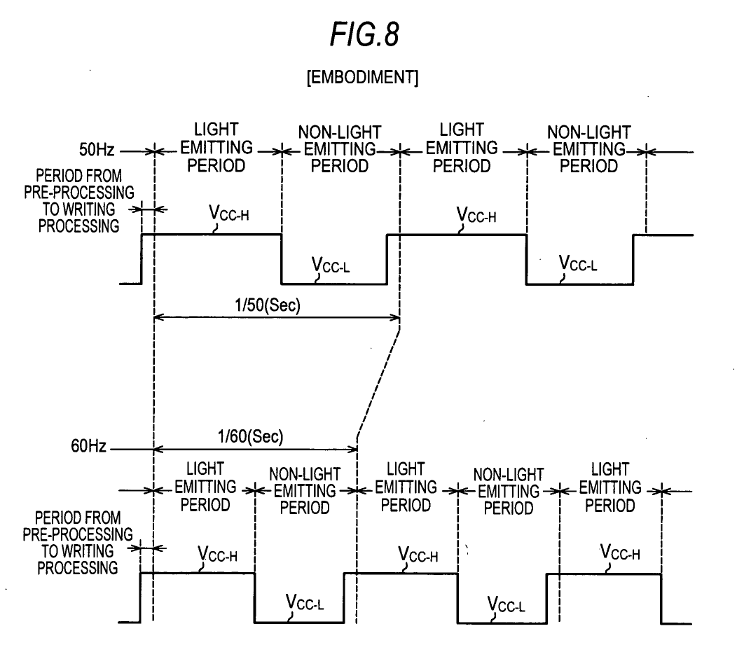

Here, the difference generated in the current amount flowing into the light emitting portion ELP in the case where the frame frequency is relatively low (for example, 50 Hz) and in the case where the frame frequency is relatively high (for example, 60 Hz) will be considered. As shown in FIG. 8, when the frame frequency is increased, the length obtained by adding the light emitting period to the non-light emitting period is reduced. Therefore, when the frame frequency is increased, the period in which the drive voltage V_{CC-H} is applied to the feeding line PS1ₘ is also reduced in general.

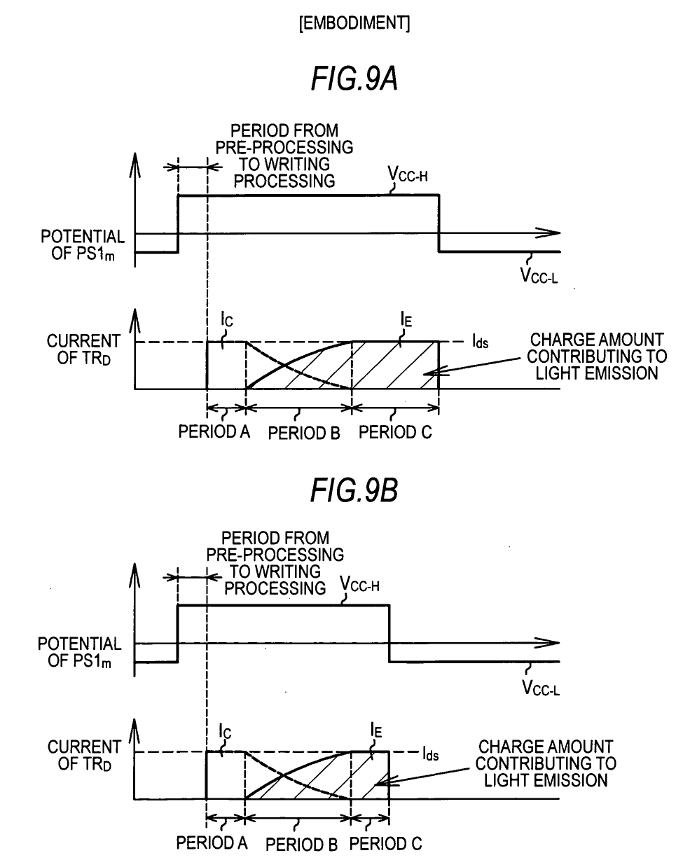

FIG. 9A is a schematic chart for explaining a portion which contributes to light emission in the drain current I_{ds} flowing through the drive transistor TR_{D} when the frame frequency is relatively low (50 Hz). FIG. 9B is a schematic chart for explaining a portion which contributes to light emission in the drain current I_{ds} flowing through the drive transistor TR_{D} when the frame frequency is relatively high (60 Hz). When the value of the video signal V_{Sig} is a fixed, the length of the period “A” and the length of the period “B” are fixed regardless of the value of the frame frequency.

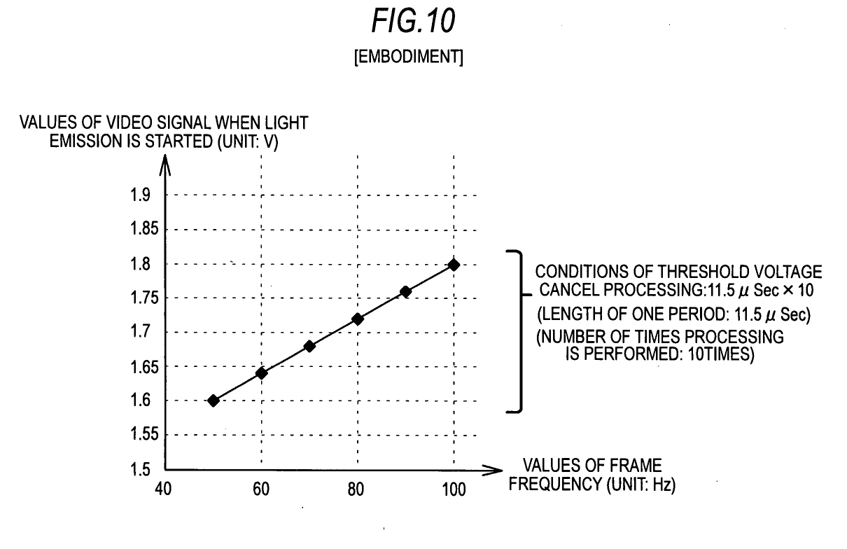

Accordingly, the higher the frame frequency is, the shorter the length of the period “C” becomes. Even when the value of the video signal V_{Sig} is fixed, the portion which contributes to light emission in the drain current I_{ds} is reduced as the frame frequency is increased. Accordingly, the voltage of the video signal V_{Sig} (voltage of black display) which is visible when the display device starts emitting light will be changed according to the value change of the frame frequency. FIG. 10 shows values of the video signal V_{Sig} which is visible when the display device starts emitting light when the frame frequency is changed while maintaining conditions of the threshold voltage cancel processing (actual conditions will be described later). As shown in FIG. 10, it can be seen that the value of the video signal V_{Sig} in a so-called black level is increased as the frame frequency is increased.

Advantages obtained by reducing the sum of lengths of periods during which the threshold voltage cancel processing is performed will be explained with reference to FIG. 11. FIG. 11 is a timing chart obtained when timings of initialization and the like are delayed by one horizontal scanning period with respect to the timing chart of FIG. 4. In operations shown in FIG. 11, the potential increase of the second node ND₂ in the threshold voltage cancel processing in [Period-TP(2)₃] shown in FIG. 4 is not generated. The potential of the second node ND₂ in the threshold voltage cancel processing in [Period-TP(2)₄] shown in FIG. 4 is not increased, either. Therefore, the voltage difference between the first node ND₁ and the second node ND₂ after the writing processing is performed in [Period-TP(2)_{6B}] becomes larger than the difference when performing the operation shown in FIG. 4. That is, even when the value of the video signal V_{Sig} is the same, the value of the drain current I_{ds} in [Period-TP(2)₇] is increased by reducing the sum of lengths of periods during which the threshold voltage cancel processing is performed.

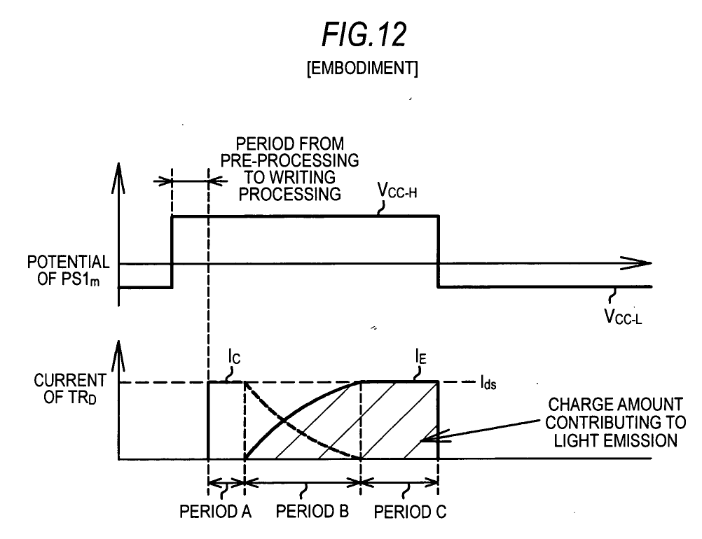

Therefore, when the display device is so driven as to reduce the sum of lengths of periods during which the threshold voltage cancel processing is performed, the value of the drain current I_{ds} is increased. The length of the period “C” is relatively reduced when the frame frequency is increased, however, the value of the drain current I_{ds} is increased when the drive device is so driven as to reduce the sum of lengths of periods during which the threshold voltage cancel processing is performed. FIG. 12 is a diagram corresponding to FIG. 9B, which is a schematic diagram for explaining the portion which contributes to light emission in the drain current I_{ds} flowing through the drive transistor TR_{D} when the sum of lengths of periods during which the threshold voltage cancel processing is performed is reduced in the case where the frame frequency is relatively high. When the value of the drain current I_{ds} in FIG. 12 is so set that the area of the hatched portion shown in FIG. 9A is the same as the area of a hatched portion shown in FIG. 12, the phenomenon in which the value of the video signal V_{Sig} in the so-called black display is increased as the frame frequency is increased can be cancelled.

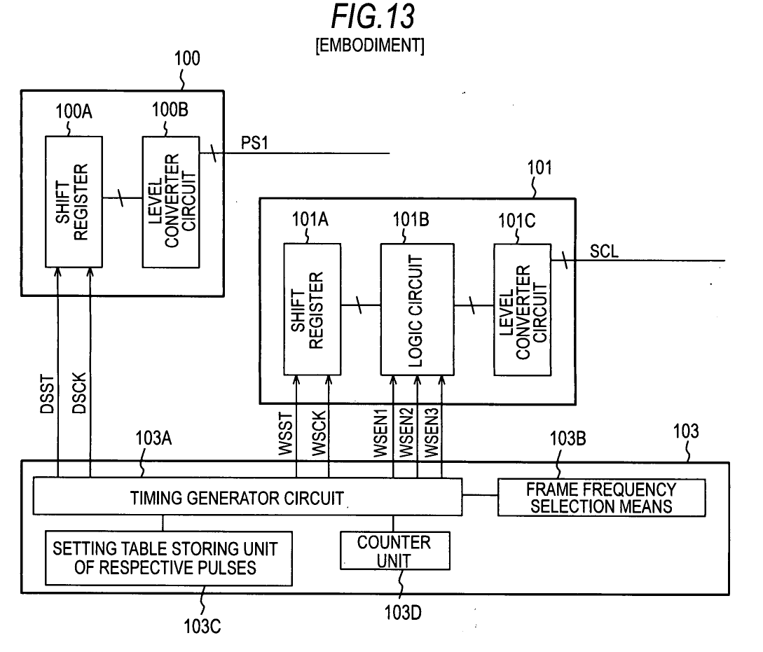

The basic principle of the drive method of the display device according to the embodiment has been explained as the above. Next, a configuration and the drive method of the display device according to the embodiment will be explained in more detail with reference to FIG. 13 to FIG. 24.

FIG. 13 is a schematic configuration diagram for explaining a configuration of the power supply unit 100, the scanning circuit 101 and the control circuit 103.

The control circuit 103 includes a timing generator circuit 103A, a frame frequency selection unit 103B, a setting table storing unit of respective pulses 103C and a counter unit 103D. To the timing generator circuit 103A, a signal based on the value of the selected frame frequency is inputted from the frame frequency selection unit 103B. The timing generator circuit 103A refers to the setting table storing unit of respective pulses 103C corresponding to the value of the frame frequency. Then, operations of the scanning circuit 101 and the power supply unit 100 are controlled by outputting later-described various signals based on the obtained set value and a signal from the counter unit 103D.

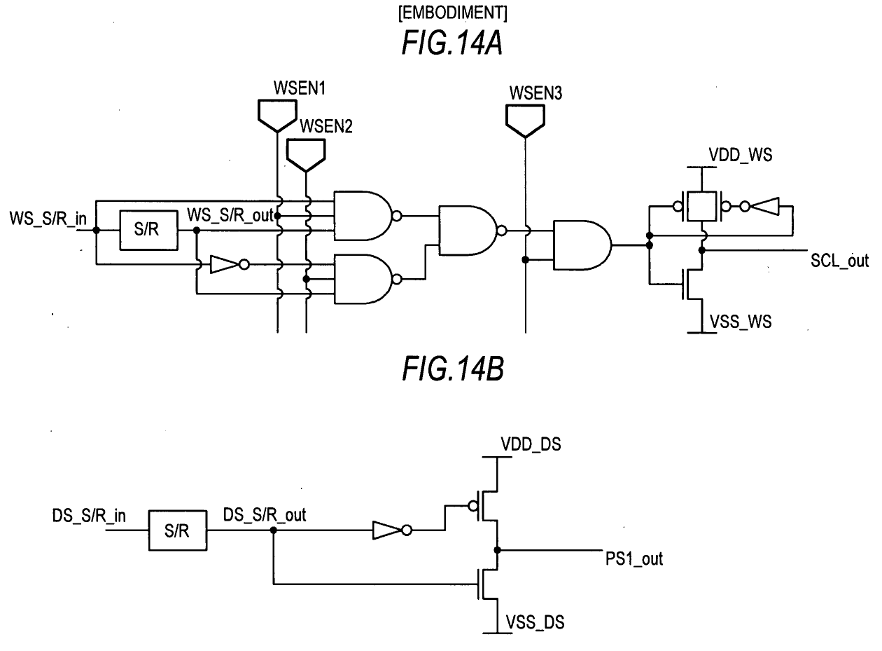

The power supply unit 100 includes a shift register unit 100A and a level converter circuit 100B. The scanning circuit 101 includes a shift register unit 101A, a logic circuit unit 101B and a level converter circuit 101C. A configuration of part of the scanning circuit 101 corresponding to one scanning line SCL is shown in FIG. 14A. A configuration of part of the power supply unit 100 corresponding to one feeding line PS1 is shown in FIG. 14B.

The control circuit 103 applies a start pulse DSST and a clock signal DSCK to the power supply unit 100 at predetermined timings. The control circuit 103 also applies a start pulse WSST, a clock signal WSCK, a first enable signal WSEN1, a second enable signal WSEN2 and a third enable signal WSEN3 to the scanning circuit 101. The start pulse DSST is applied to the first stage of the shift register unit 100A of the power supply unit 100 and the start pulse WSST is applied to the first stage of the shift register unit 101A of the scanning circuit 101. These signals are not shown in FIG. 14A and FIG. 14B. In FIG. 14A, notation of the clock signal WSCK is omitted. Similarly, notation of the clock signal DSCK is omitted in FIG. 14B.

Codes V_{DD}_{_{—}}_{WS}, V_{SS}_{_{—}}_{WS} shown in FIG. 14A and codes V_{DD}_{_{—}}_{DS}, V_{SS}_{_{—}}_{DS} shown in FIG. 14B are power supply voltages to be applied to level shift circuits. A code SCL_{—}_{^{out}} shown in FIG. 14A represents an output signal to be applied to the scanning line SCL and a code PS1_{—}_{^{out}} shown in FIG. 14B represents an output signal to be applied to the feeding line PS1. Codes WS_{—}_{^{S/R}}_{—}_{ⁱⁿ}, WS_{—}_{^{S/R}}_{—}_{^{out}} shown in FIG. 14A are respectively an input signal and an output signal of the shift register unit of the scanning circuit 101. Similarly, codes DS_{—}_{^{S/R}}_{—}_{ⁱⁿ}, DS_{—}_{^{S/R}}_{—}_{^{out}} shown in FIG. 14B are respectively an input signal and an output signal of the shift register unit of the power supply unit 100.

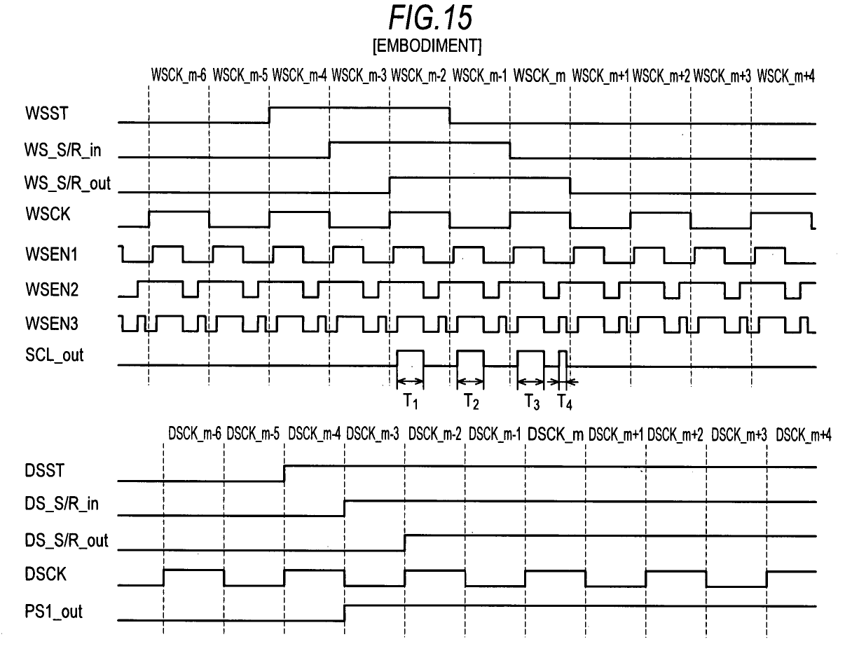

FIG. 15 is a schematic timing chart for explaining operations of the control circuit 103, the scanning circuit 101 and the power supply units 100. FIG. 15 is the timing chart corresponding to FIG. 4, and a period T₁ shown in FIG. 15 corresponds to the period from the beginning of [Period-TP(2)_{1A}] to the end of [Period-TP(2)_{1B}]. Periods T₂, T₃ respectively correspond to [Period-TP(2)₃] and [Period-TP(2)₅]. A period T₄ shown in FIG. 15 corresponds to [Period-TP(2)_{6B}] shown in FIG. 4.

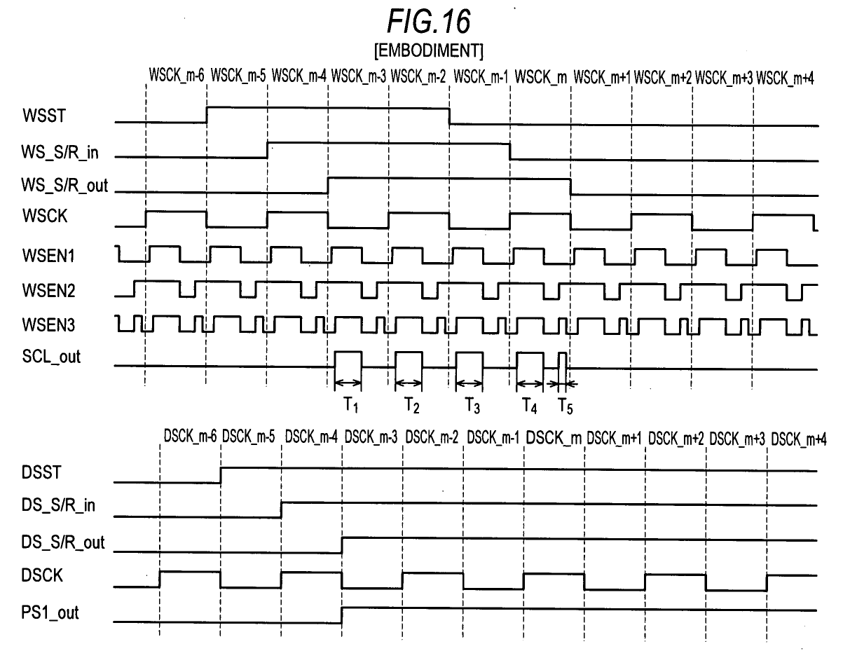

FIG. 16 is also a schematic timing chart for explaining operations of the control circuit 103, the scanning circuit 101 and the power supply unit 100. FIG. 16 is the timing chart in which the timing of initialization is performed earlier than the case of FIG. 15 by one horizontal scanning period as well as the number of times the threshold voltage cancel processing is performed is increased once. In the circuit configuration explained with reference to FIG. 13 and FIGS. 14A, 14B, it is possible to easily adjust the number of times the threshold voltage cancel processing is performed and the length of the period in which one threshold voltage cancel processing is performed by changing various signals supplied from the control circuit 103.

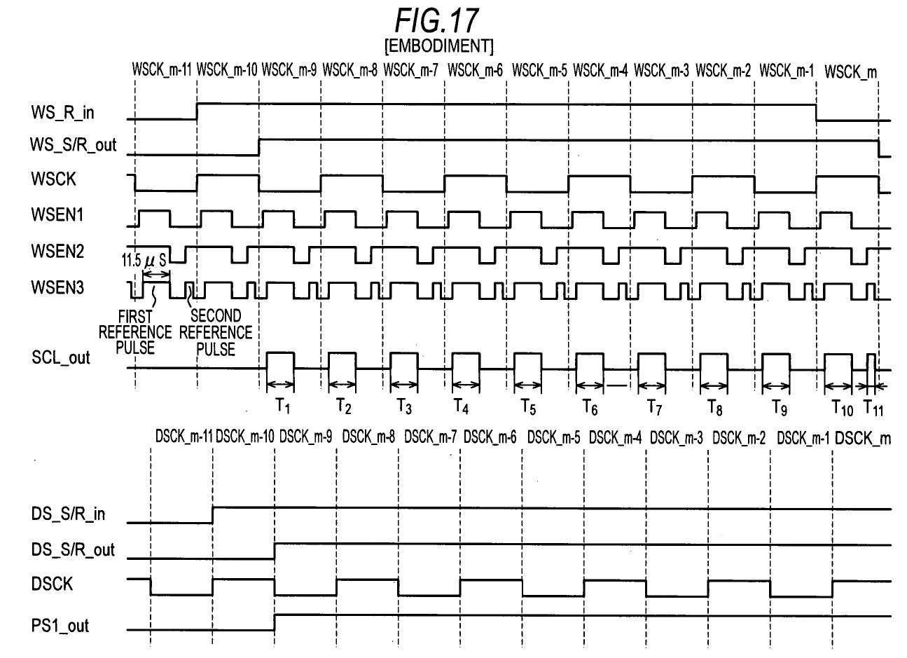

Data shown in FIG. 10 was measured by performing initialization to the writing processing in a timing chart shown in FIG. 17 and the display device is driven by respective frame frequencies. In periods T₁ to T₁₀ shown in FIG. 17, the threshold voltage cancel processing is performed, and in a period T₁₁ shown in FIG. 17, the writing processing is performed. The length of each period of the periods T₁ to T₁₀ is prescribed by a first reference pulse in the third enable signal WSEN3, which is set to 11.5 ms. The length of the period T₁₁ prescribing the writing period is prescribed by a second reference pulse in the third enable signal WSEN3. In the embodiment, the second reference pulse is set to a fixed length regardless of the frame frequency.

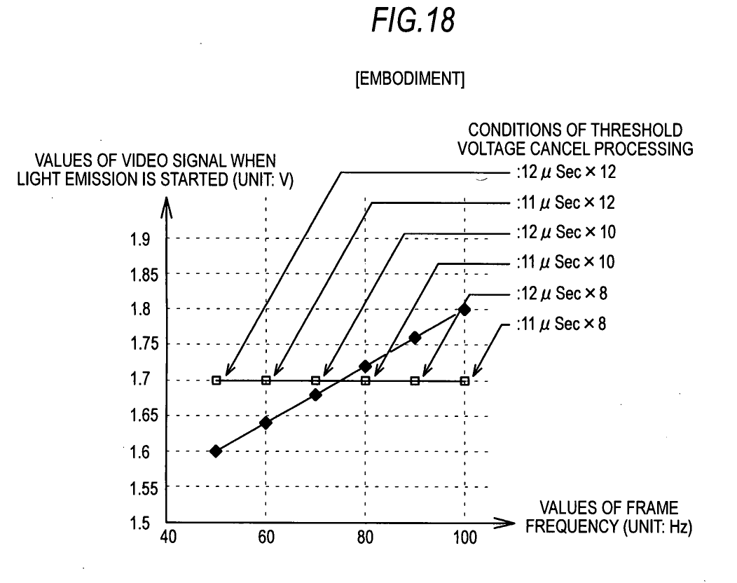

FIG. 18 is a graph corresponding to FIG. 17, which is a schematic graph for explaining the relation between the frame frequency and the value of video signal V_{Sig} when light emission is started in the display device in the case where the condition of the threshold voltage cancel processing is changed according to the frame frequency.

When the display device is driven by a given frame frequency FR, the number of times the threshold voltage cancel processing is performed is represented as P(FR) and the length of the period in which one threshold voltage cancel processing is performed is represented as TU(FR) in the step (a). When the first frame frequency is represented as FR₁ and the second frame frequency which is higher than the first frame frequency is represented as FR₂, the display device is so controlled as to satisfy TU(FR₁−)·P(FR₁)>TU(FR₂)·P (FR₂) as described later.

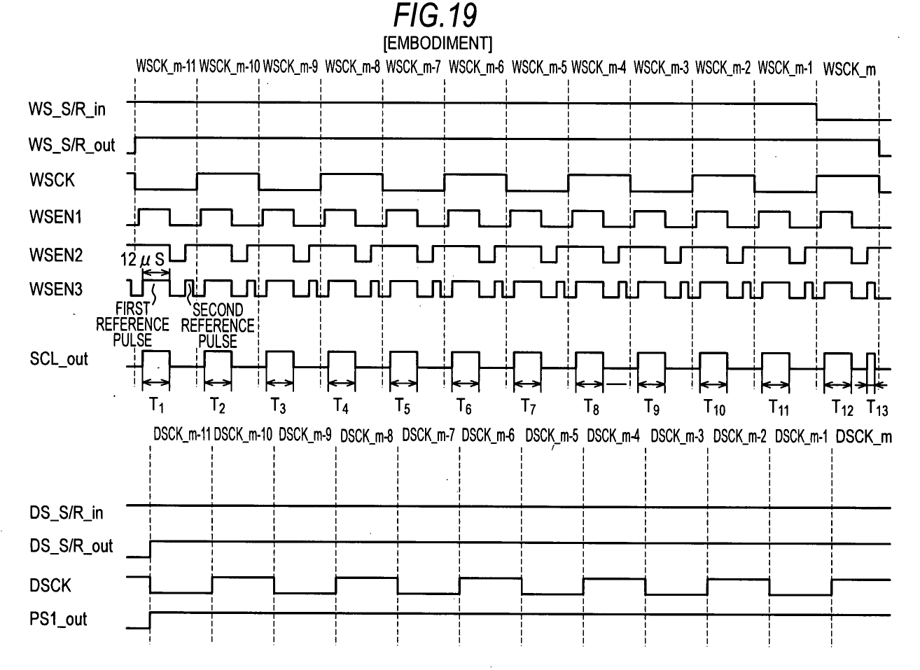

A timing chart obtained when the frame frequency is 50 Hz is shown in FIG. 19. At this time, the first reference pulse in the third enable signal WSEN3 is set to 12 sm, and threshold voltage cancel processing is performed in periods T₁ to T₁₂ shown in FIG. 19. At this time, TU(50)·P(50)=12·12=144 ms.

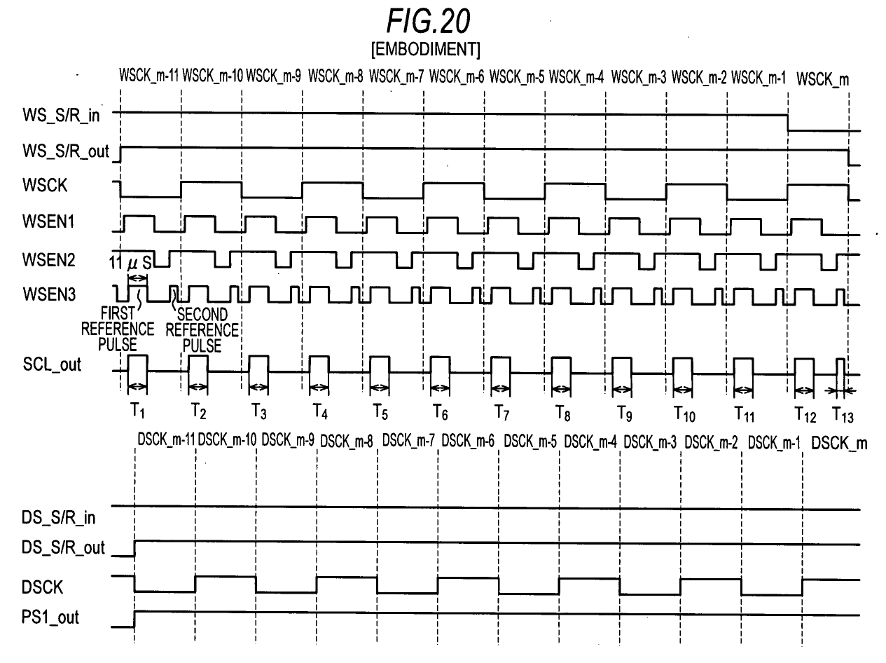

A timing chart obtained when the frame frequency is 60 Hz is shown in FIG. 20. At this time, the first reference pulse in the third enable signal WSEN3 is set to 11 sm, and threshold voltage cancel processing is performed in periods T₁ to T₁₂ shown in FIG. 20. At this time, TU(60)·P (60)=11·12=132 ms.

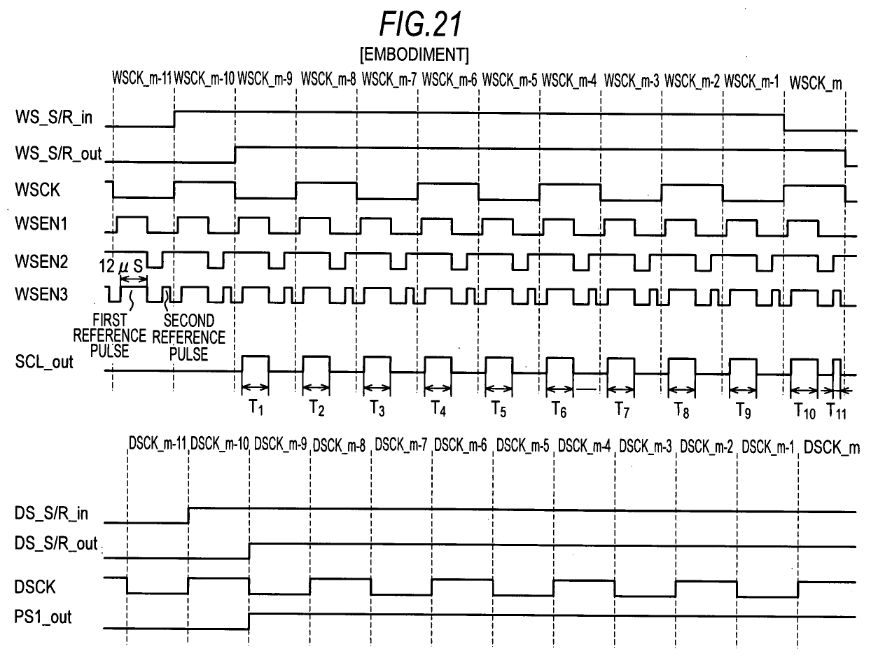

A timing chart obtained when the frame frequency is 70 Hz is shown in FIG. 21. At this time, the first reference pulse in the third enable signal WSEN3 is set to 12 sm, and threshold voltage cancel processing is performed in periods T₁ to T₁₀ shown in FIG. 21. At this time, TU(70)·P(70)=12·10=120 ms.

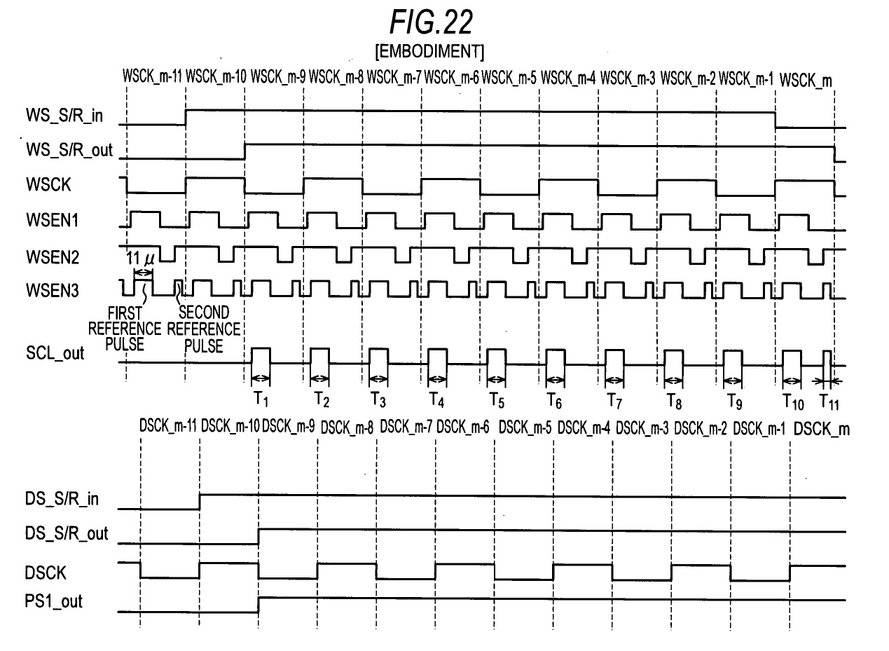

A timing chart obtained when the frame frequency is 80 Hz is shown in FIG. 22. At this time, the first reference pulse in the third enable signal WSEN3 is set to 11 sm, and threshold voltage cancel processing is performed in periods T₁ to T₁₀ shown in FIG. 22. At this time, TU(80)·P(80)=11·10=110 ms.

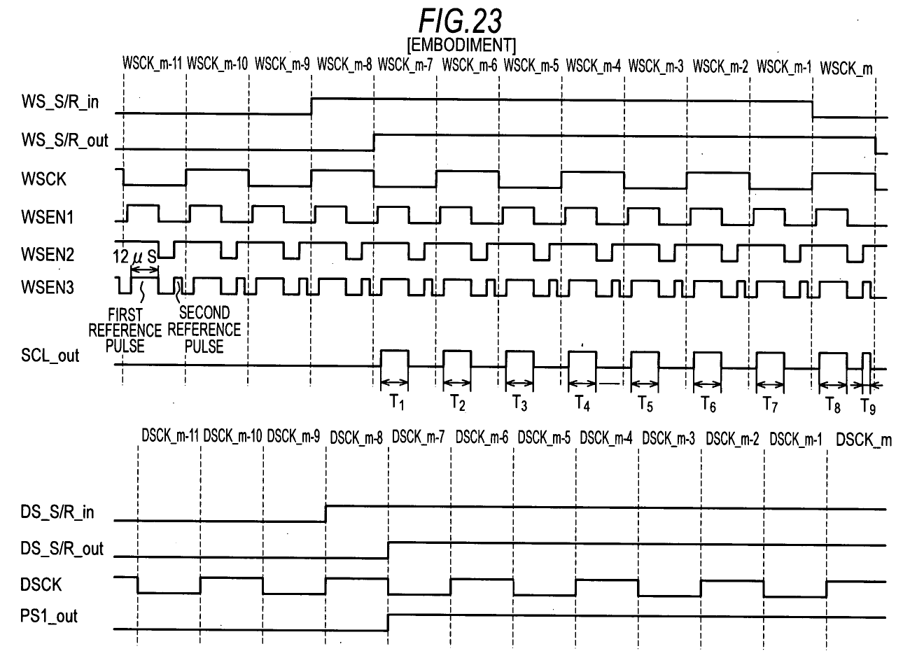

A timing chart obtained when the frame frequency is 90 Hz is shown in FIG. 23. At this time, the first reference pulse in the third enable signal WSEN3 is set to 12 sm, and threshold voltage cancel processing is performed in periods T₁ to T₈ shown in FIG. 23. At this time, TU(90)·P(90)=12·8=96 ms.

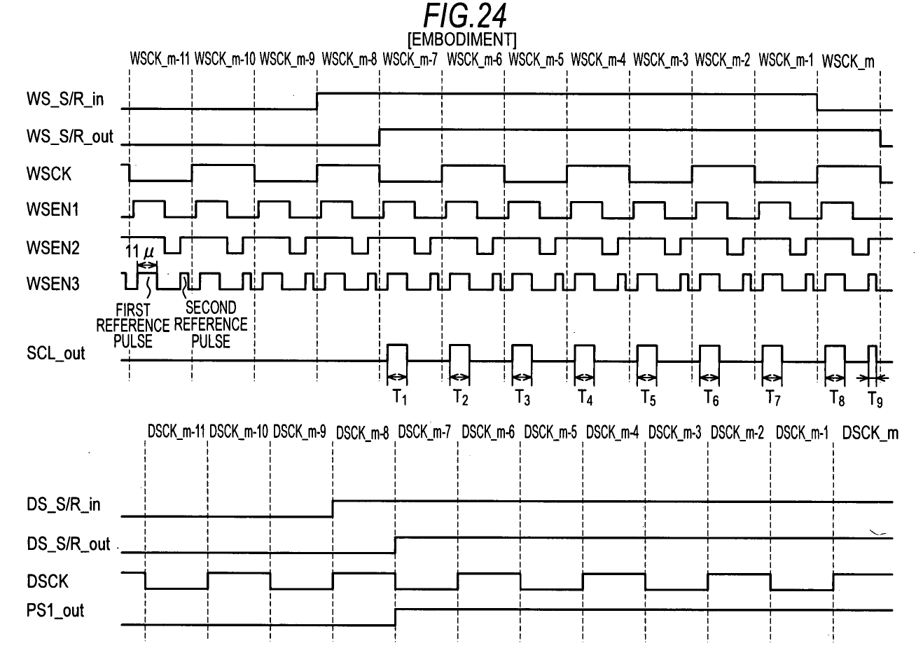

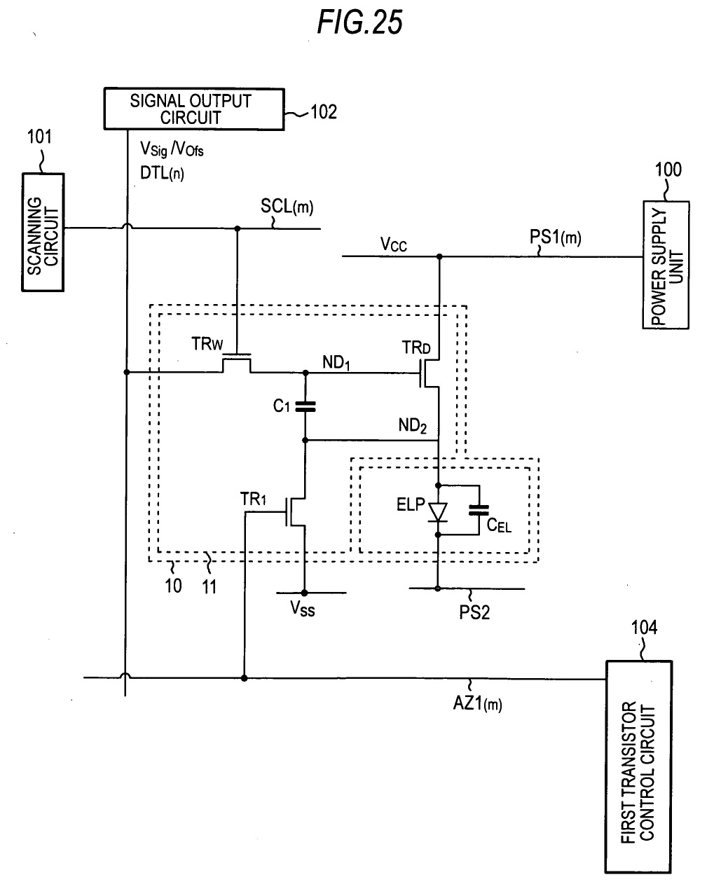

A timing chart obtained when the frame frequency is 100 Hz is shown in FIG. 24. At this time, the first reference pulse in the third enable signal WSEN3 is set to 11 sm, and threshold voltage cancel processing is performed in periods T₁ to T₈ shown in FIG. 23. At this time, TU(100)·P(100)=11·8=88 ms.

As described above, the condition of the threshold voltage cancel processing is changed according to the frame frequency, thereby adjusting values of the video signal V_{Sig} which is seen when the display device emits light to a fixed value regardless of the value of the frame frequency. Therefore, it is not necessary to adjust values of the video signal according to the frame frequency, and pictures can be displayed in respective frame frequencies in good condition. P(FR) and TU(FR) can take various values according to design of the display device. Therefore, the display device is driven in various operation conditions to perform measurement and suitable values may be selected and used according to frame frequencies.

The invention has been explained based on the preferred embodiment as the above, and the invention is not limited to the embodiment. The configurations and structures of the display device and the display element as well as steps of the drive method of the display element and the display device explained in the embodiment are just shown as examples and can be changed appropriately.

For example, it is preferable to apply a configuration which the drive circuit 11 included in the display element 10 has a transistor (first transistor TR₁) connected to the second node ND₂. In the first transistor TR₁, a second node initialization voltage V_{SS} is applied to one source/drain region, and the other source/drain region is connected to the second node ND₂. A signal from a first transistor control circuit 104 is applied to a gate electrode of the first transistor TR₁ through a first transistor control line AZ1 to control the ON/OFF state of the first transistor TR₁. According to this, the potential of the second node ND₂ can be set.

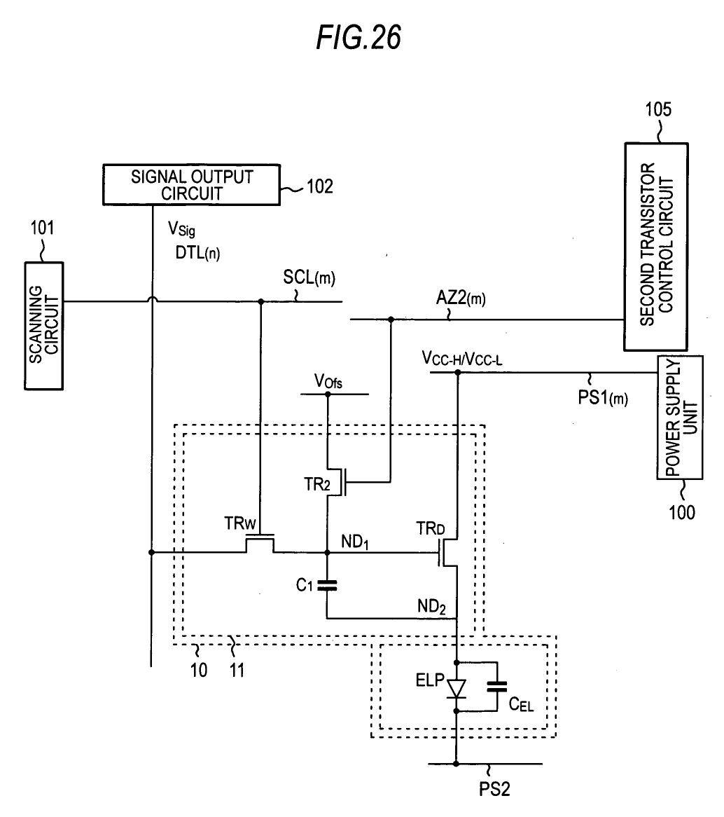

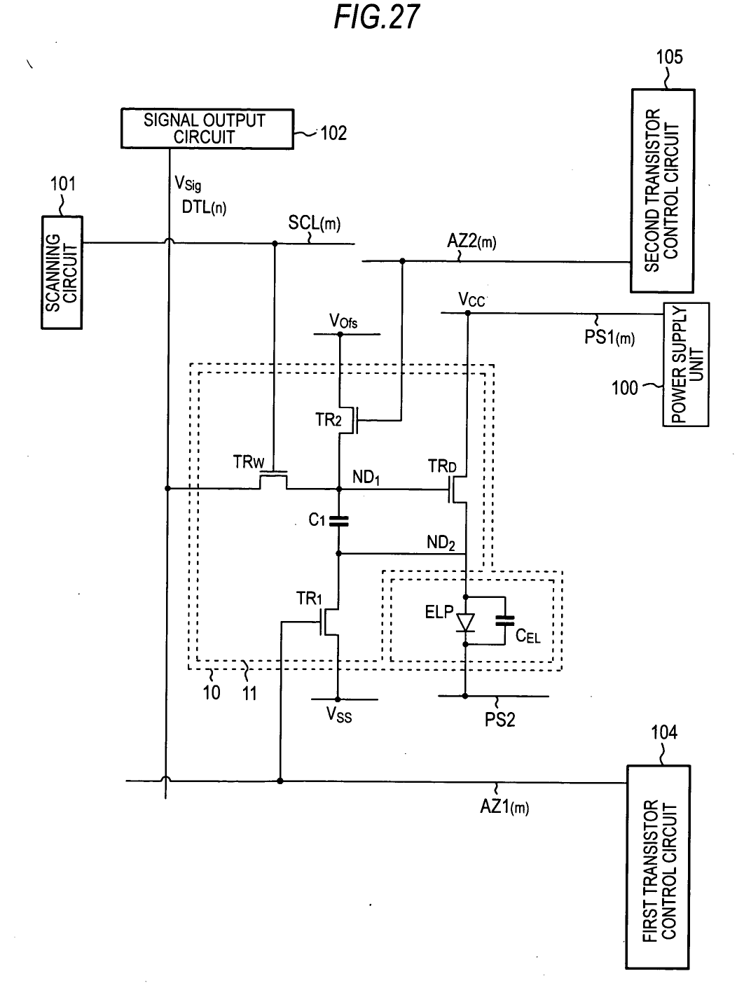

Additionally, it is preferable to apply a configuration in which the drive circuit 11 included in the display element 10 has a transistor (second transistor TR₂) connected to the first node ND₁ as shown in FIG. 26. In the second transistor TR₂, the first node initialization voltage V_{ofs} is applied to one source/drain region, and the other source/drain region is connected to the first node ND₁. A signal from a second transistor control circuit 105 is applied to a gate electrode of the second transistor TR₂ through a second transistor control line AZ2 to control the ON/OFF state of the second transistor TR₂. According to this, the potential of the first node ND₁ can be set.

Furthermore, it is also possible to apply a configuration in which the drive circuit 11 included in the display element 10 has both the first transistor TR₁ and the second transistor TR₂. It is also preferable to apply a configuration in which another transistor is included in addition to the above transistors.

In the embodiment, the explanation has been made assuming that the drive transistor TR_{D} is an n-channel transistor. In the case where the drive transistor TR_{D} is a p-channel transistor, it is preferable to perform wire connection in which the anode electrode and the cathode electrode of the light emitting portion are replaced with each other. In the configuration, the direction in which the drain current flows is changed, therefore, the voltage value to be applied to the feeding line and the like may be suitably changed.

The present application contains subject matter related to that disclosed in Japanese Priority Patent Application JP 2009-133606 filed in the Japan Patent Office on Jun. 3, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A drive method of a display device, which uses the display device including
(1) the total N×M pieces of display elements in which N-pieces in a first direction and M-pieces in a second direction different from the first direction are arranged in a two-dimensional matrix state, each having a current-drive type light emitting portion and a drive circuit,
(2) M-pieces of scanning lines extending in the first direction,
(3) N-pieces of data lines extending in the second direction and
(4) M-pieces of feeding lines extending in the first direction,
in which the drive circuit includes a write transistor, a drive transistor and a capacitor unit,
in the display element of the m-th row (m=1, 2 . . . , M) and the n-th column (n=1, 2 . . . , N)
in the drive transistor,
(A-1) one source/drain region is connected to the m-th feeding line,
(A-2) the other source/drain region is connected to one end of the light emitting portion as well as connected to one electrode of the capacitor unit, which configures a second node, and
(A-3) a gate electrode is connected to the other source/drain region of the write transistor as well as connected to the other electrode of the capacitor unit, which configures a first node,
in the write transistor,
(B-1) one source/drain region is connected to the n-th data line, and
(B-2) the gate electrode is connected to the m-th scanning line, the drive method comprising the steps of:
(a) performing threshold voltage cancel processing at least once, which changes a potential of the second node toward a potential obtained by subtracting a threshold voltage of the drive transistor from a potential of the first node by applying a given drive voltage to one source/drain region of the drive transistor from the feeding line while maintaining the potential of the first node; and then,
(b) performing writing processing which applies a video signal to the first node from the data line through the write transistor,
wherein the sum of lengths of periods in which the threshold voltage cancel processing is performed is so set as to be shorter as a frame frequency becomes higher.

2. The drive method of the display device according to claim 1,
wherein TU(FR₁)·P(FR₁)>TU(FR₂)·P(FR₂) is satisfied,
in the case where the display device is driven by a given frame frequency FR, when the number of times the threshold voltage cancel processing is performed is represented as P(FR), a length of a period during which one threshold voltage cancel processing is performed is represented as TU(FR), and a first frame frequency is represented as FR₁ and a second frame frequency which is higher than the first frame frequency is FR₁ is represented as FR₂.

3. The drive method of the display device according to claim 1,
wherein pre-processing initializing the potential of the first node and the potential of the second node is performed,
subsequently, the step (a) and the step (b) are performed,
after that, the write transistor is turned off by a scanning signal from the scanning line to thereby allow the first node to be in a floating state, and electric current corresponding to a value of voltage difference between the first node and the second node is allowed to flow into the light emitting portion through the drive transistor in a state in which the given drive voltage is applied to one source/drain region of the drive transistor from the feeding line to thereby drive the light emitting portion.

4. The drive method of the display device according to claim 3,
wherein the light emitting portion includes an anode electrode and a cathode electrode,
the pre-processing is the step of setting the potential of the first node and the potential of the second node so that potential difference between the gate electrode and the other source/drain region of the drive transistor exceeds the threshold of the drive transistor as well as potential difference between the anode electrode and the cathode electrode of the light emitting portion does not exceed a threshold voltage of the light emitting portion.

5. The drive method of the display device according to claims 1,
wherein the light emitting portion is made of an organic electroluminescence light emitting portion.

6. The drive method of the display device according to claim 2,
wherein pre-processing initializing the potential of the first node and the potential of the second node is performed,
subsequently, the step (a) and the step (b) are performed,
after that, the write transistor is turned off by a scanning signal from the scanning line to thereby allow the first node to be in a floating state, and electric current corresponding to a value of voltage difference between the first node and the second node is allowed to flow into the light emitting portion through the drive transistor in a state in which the given drive voltage is applied to one source/drain region of the drive transistor from the feeding line to thereby drive the light emitting portion.
